(19) United States
(12) Patent Application Publication
(10) Pub. No.: US 2015/0263586 A1
(43) Pub. Date: Sep. 17, 2015

(54) MOTORIZATION UNIT FOR MANUAL STAGE, AND MANUAL STAGE HAVING MOTORIZATION UNIT

(71) Applicant: MIRUC OPTICAL CO., LTD., Hachioji-shi, Tokyo (JP)

(72) Inventor: Hiroaki Muramatsu, Hachioji-shi (JP)

(73) Assignee: MIRUC OPTICAL CO., LTD., Hachioji-shi, Tokyo (JP)

(21) Appl. No.: 14/433,790

(22) PCT Filed: Oct. 2, 2013
(86) PCT No.: PCT/JP2013/077405

§ 371 Date: Apr. 6, 2015

(30) Foreign Application Priority Data
Oct. 5, 2012 (JP) PCT/JP2012/076559

(51) Int. Cl. H02K 7/00; H02K 7/14

(52) U.S. Cl. CPC H02K 7/003; H02K 7/14

(57) ABSTRACT

By removably attaching a simplified mechanism to a prior-art stage for moving a sliding component by manual rotation of a control knob, an automatic mode and a manual mode can be made selectable and moreover, a motorization unit for a manual stage capable of fine adjustment by manual operation and a manual stage with the motorization unit is provided.

A motorization unit for a manual stage is provided with a clamp for preventing co-rotation by sandwiching a sliding component or a fixed component of a manual stage, a coupling coupled to a control knob while holding substantial coaxiality with a control knob shaft, a coupling claw for gripping a knob portion, and a motor for rotating the coupling, either one of manual operation and automatic operation being selected by removal from/attachment to the manual stage, and constitutes a manual stage with the motorization unit by being equipped to the manual stage.

### TECHNICAL FIELD

The present invention relates to a motorization unit for manual stage and manual stage having motorization unit, and particularly to a motorization unit which is attached to a manual stage for manually moving a sliding component or a fixed component and automatically moves the sliding component or the fixed component and a manual stage equipped with this motorization unit.

### BACKGROUND ART

For example, electric/electronic devices such as a CCD camera and a sensor, optical devices such as a lens and a microscope, and illumination devices such as an LED, need positional adjustment for positioning or focusing when attaching them in some cases. Moreover, after attaching them, their positions need to be further adjusted finely in some cases. The above-described electric/electronic devices, optical devices, illumination devices and the like are installed on a mechanical element called a “stage” in general for positional adjustment or fine adjustment. In this specification, devices requiring the positional adjustment or fine adjustment for positioning or focusing are collectively called “precision devices”.

Among these stages, those moving the precision device by a control knob operation by a user are called “manual stages” and they are composed of a sliding component, a fixed component and a control knob. This manual stage is a device in which the sliding component is coupled to the fixed component via a sliding mechanism, and the sliding component is moved with respect to the fixed component by rotating operation of the control knob provided on the sliding component or the fixed component around its shaft in order to perform the positional adjustment of the precision device. This manual stage includes, for example, a dovetail groove stage, a feed-screw stage, a linear-ball type stage, a cross-roller type stage, a simplified ball type stage, a dovetail groove slide-rail type stage and the like depending on the sliding mechanism. Moreover, the stages have various styles according to a purpose of use and in the case of the dovetail groove stage, for example, an X-axis dovetail groove stage sliding in one direction, an XY-axis dovetail groove stage sliding in two directions substantially orthogonal to each other, a Z-axis dovetail groove stage sliding in a vertical direction and the like are included.

FIGS. 6 to 16 illustrate examples of the above-described various styles. FIG. 6 is an example of the X-axis stage. FIG. 7 is an example of the X-axis stage (extended control knob type). FIG. 8 is an example of the XY-axis stage. FIG. 9 is an example of the Z-axis stage. FIG. 10 is an example of the X-axis stage. FIG. 11 is an example of the Z-axis stage. FIG. 12 is an example of the X-axis stage. FIG. 13 is an example of the X-axis stage (dovetail groove feed-screw type). FIG. 14 is an example of the X-axis stage (dovetail groove slim feed-screw type). FIG. 15 is an example of the X-axis stage (dovetail groove slim feed-screw type). And FIG. 16 is an example of the X-axis stage.

The manual stage performs positional adjustment of a precision device by moving the sliding component with respect to the fixed component by the driving mechanism. This driving mechanism includes, for example, a rack-and-pinion used mainly in a dovetail groove stage, a male-threaded rod and a female-threaded cylinder used mainly in a feed-screw stage and the like. Moreover, as the driving mechanism, an automatic stage or an electric stage operated automatically or electrically, not manually, is included.

The precision device is attached to a precision device attaching hole provided on an upper side of the sliding component in the stage by a fastening tool. Moreover, the fixed component of the stage is fixed to a base by screwing the fastening tool into a base fixing hole. This manual stage is fixed at an arbitrary position on the fixed component by tightening a sliding lock screw provided on the sliding component and can move on the fixed component by loosening this sliding lock screw.

With reference to FIG. 2 of Patent Literature 1, a driving mechanism for a rack-and-pinion type manual stage is described. The driving mechanism according to a rack and a pinion gear is a driving mechanism in which a rack (reference numeral 13 in FIG. 2 of Patent Literature 1) fixed to a sliding component or a fixed component is engaged with a pinion gear (reference numeral 14 of the same) in which a control knob and a revolving shaft are connected to be identical and which is supported by a fixed component or a sliding component, and upon rotation of the control knob (reference numeral 9 of the same), the pinion gear interlockingly rotates to move on the rack and the sliding component slides with respect to the fixed component. That is, this is the driving mechanism in which the rack and the pinion gear are operated by rotationary driving the control knob. Combined with a sliding mechanism referred to as a dovetail groove type stage, to be described below, the rack-and-pinion-type manual stage is a driving mechanism which moves about 18 mm in one turn of the control knob and is suitable when a quick, wide motion is needed.

With reference to FIG. 22 of Patent Literature 1, a driving mechanism for a feed-screw-type manual stage is described. A feed-screw-type driving mechanism is a driving mechanism for moving a sliding component with respect to a fixed component by engaging a female-threaded cylinder (reference numeral 306 in FIG. 22 of Patent Literature 1) connected to a rear face of a sliding component to which a precision device is mounted with a male-threaded rod (reference numeral 307 of the same) penetrating a block fixed to the fixed component connected to a base, and rotating the male-threaded rod through operation of a control knob (reference numeral 309 of the same). That is, this is the driving mechanism in which the female-threaded cylinder and the male-threaded rod are operated by rotationary driving the control knob. Combined with a sliding mechanism referred to as a dovetail groove type stage, to be described below, the feed-screw-type manual stage is a driving mechanism which moves about 0.5 mm, about 1.0 mm, about 2.0 mm, about 4.2 mm, about 5.0 mm or about 10.0 mm depending on a device type in one turn of the control knob, and is suitable when load bearing is required and fine adjustment is needed.

The sliding mechanism by using a dovetail groove will be described with reference to FIG. 1 in Patent Literature 1. In the rack-and-pinion manual stage and the feed-screw manual stage, a dovetail manual stage is generally used as a sliding mechanism for smoothly sliding the sliding component with respect to the fixed component. The dovetail groove manual stage refers to a manual stage in which a fixed component having a trapezoidally-recess dovetail groove (reference numeral 3 in FIG. 1 of Patent Literature 1) is fitted with a sliding component having a trapezoidally-projecting dovetail (reference numeral 2 of the same), and the sliding component smoothly slides with respect to the fixed component.

This dovetail groove stage includes only a manual stage, and an automatic stage (or an electric stage) in which a stage and a rotationary driving mechanism such as a motor are integrated has not been developed yet. On the other hand, in a linear-ball type stage, a cross-roller type stage and the like provided with other sliding mechanisms different from that of the dovetail groove stage, an automatic stage having a motor, a control device and the like embedded therein has been already developed. It should be noted that, this automatic stage (or the electric stage) cannot be operated manually but only automatic operation (or electric operation) is possible because of its mechanism.

Moreover, FIG. 11 in Patent Literature 2 discloses a system performing rotational control of the control knob by using an electric motor. Here, a clamp member (reference numeral 409 in FIG. 11) is connected to a first block through a first washer, and a rotating operation portion (reference numeral 406 in FIG. 11) is connected to the clamp member through a second washer. Moreover, to the rotating operation portion, an electric motor (reference numeral 32 in FIG. 11) is coupled to a control device (reference numeral 33 in FIG. 11) by a coupler (reference numeral 31 in FIG. 11). That is, the electric motor is coupled to an end portion of the rotating operation portion through the coupler, rotates a male-threaded rod through rotating operation of the electric motor and moves the sliding component with respect to the fixed component.

Moreover, Patent Literature 3 discloses a highly functional manual stage unit and a manual stage constituting system in which a component to be attached to a manual stage main body can be selected in accordance with ease of use, required functions, and an application to be used. As illustrated in FIG. 9, it is disclosed that a “control knob component (group) (reference numerals 5a to 5e in FIG. 9)” is selected and attached to a “manual stage main body (reference numeral 2 in FIG. 6)” illustrated in FIG. 6. FIG. 9(e) illustrates an electric control knob component (reference numeral 5e in FIG. 9) to be connected to an electric motor and a control device by a coupler further wrapping the control knob component coupled to control knob coupling means, and for performing rotational control of the control knob by using the electric motor. These control knob components are all constituted to be engaged with a tip-end threaded portion of the control knob coupling means of the manual stage main body, and by selecting this electric control knob component, the manual stage can be extendedly used as the electric stage.

### CITATION LIST

### Patent Literature

Patent Literature 1: Japanese Patent No. 4606501B2

Patent Literature 2: Japanese Patent No. 4890652B2

Patent Literature 3: Japanese Patent No. 4574716B2

### SUMMARY OF INVENTION

### Problems to be Solved

In an automatic stage in which a stage and a rotationary driving mechanism such as a motor are integrated or an electric stage, since an automating device such as a motor is embedded in the stage, movement of a sliding component is limited to be performed by automatic operation. Thus, it is inconvenient in some cases for users who are used to a manual stage. For example, it is inconvenient when fine movement is required for positional adjustment. In such a case, manual adjustment is more preferable, and automatic operation cannot easily replace a manual fine operation of a control knob. Moreover, if the manual fine adjustment is to be realized by automation (or electrical driving), it involves a problem that a more expensive control mechanism or control software will be needed. Moreover, since users of the stage cannot attach the integrated automatic stage to an existing manual stage, it involves a problem that they should newly purchase automatic stages.

Moreover, regarding a system for performing rotational control of a control knob by using an electric motor illustrated in Patent Literature 2 and an electric stage illustrated in Patent Literature 3, if the systems are to be put into practice so as to obtain removable units, the following three technical problems need to be solved.

First, a mechanism for preventing co-rotation of an electric unit itself with the motor rotation is required. That is, the needs to be attached to a fixed object which is not affected by rotation of the motor. Furthermore, the mechanism for preventing the co-rotation should be a mechanism which can be removably attached to the manual stage easily, which is a problem.

Secondly, in order to make the unit attachable to a sliding component or a fixed component of an existing manual stage, a generic mechanism which can be attached to a sliding component or a fixed component of various sizes is needed. Moreover, a generic mechanism which can grip a control knob of various sizes is needed in order to rotate the control knob of the manual stage. Furthermore, since the sliding components, fixed components, control knobs and the like have manufacturing errors, there is a problem that a mechanism that can be reliably attached by handling the manufacturing errors and is capable of reliable gripping is required.

Thirdly, even if the stage is automated or electrically driven, a mechanism which can easily make fine adjustment of a position of a stage is still needed. That is, availability of fine adjustment, which is a merit of the manual stage, is also required for the automatic stage (or electric stage). In this regard, in order to make this fine adjustment in the automatic stage (or the electric stage), a complicated control mechanism and control software for operating it are needed, which causes a problem that it is not economical.

The present application has an object to solve those problems and to provide a motorization unit for a manual stage in which automatic operation and manual operation can be freely selected by attaching/removing a simplified mechanism and moreover, fine adjustment can be performed manually as compared with a prior-art manual stage in which a sliding component or a fixed component is moved by manual rotation of a control knob; and a manual stage provided with the motorization unit.

### Solution to Problem

In order to achieve the above object, a motorization unit for a manual stage according to the present invention is attached to a manual stage in which a sliding component to which a precision device is attached and a fixed component fixed to a base are coupled to each other via a driving mechanism and the sliding component is moved by rotating operation of a control knob around its shaft in order to perform positional adjustment of the precision device. The motorization unit is provided with a rotation preventing jig for preventing co-rotation by sandwiching the sliding component or the fixed component of the manual stage, a coupling portion for driving the control knob connected to the control knob while holding substantial coaxiality with the control knob shaft, a control knob gripping portion for gripping a knob portion of the control knob, and a motor for rotating the coupling portion for driving the control knob, and is characterized in that either one of manual operation and automatic operation is selected by means of attaching/removing the unit.

By means of the above configuration, the motorization unit is removably attached to the manual stage. Then, either one of the manual operation and the automatic operation is selected by attaching/removing the motorization unit. As a result, a user can select an automatic operation mode (or an electric operation mode) by attaching a newly purchased motorization unit to an already purchased manual stage. Moreover, by removing the attached motorization unit, a mode can be returned to the manual operation mode, and convenience of use of the stage is improved. As described above, the user can appropriately choose the manual operation or the automatic operation or the electric operation on the basis of the respective merits thereof.

This motorization unit is composed of the rotation preventing jig, the coupling portion for driving the control knob, the control knob gripping portion, and the motor. Co-rotation can be prevented by the rotation preventing jig sandwiching the sliding component or the fixed component of the manual stage. Moreover, the rotation preventing jig can sandwich the sliding component or the fixed component with different sizes. Moreover, the rotation preventing jig can reliably sandwich the sliding component or the fixed component even with variation in dimensional accuracy. Moreover, the control knob can be connected by using the coupling portion for driving the control knob while holding substantial coaxiality with the control knob shaft. Furthermore, the control knob gripping portion can reliably grip the knob portion of the control knob with variation in dimensional accuracy.

Moreover, in the motorization unit for a manual stage, it is preferable that manual rotating operation of the coupling portion for driving the control knob rotates the knob portion of the control knob gripped by the control knob gripping portion so as to perform fine adjustment of a position of the precision device. As a result, in addition to the above-described manual operation and automatic operation, the control knob can be finely adjusted manually by using the coupling portion for driving the control knob by stopping the automatic operation.

Moreover, in the motorization unit for a manual stage, it is preferable that the rotation preventing jig is provided with an opening/closing mechanism which is a pair of clamps and removably sandwiches the sliding component or the fixed component by opening or closing both of tip-end portions of the clamps. As a result, co-rotation can be reliably prevented with a simple mechanism. Moreover, the rotation preventing jig can also sandwich the sliding component or the fixed component with different sizes. Furthermore, the rotation preventing jig can also reliably sandwich the sliding component or the fixed component with variation in dimensional accuracy.

Moreover, in the motorization unit for a manual stage, it is preferable that the opening/closing mechanism opens/closes the tip-end portion of one of the clamps by rotating a gear around an axis to rotate a wheel coupled to the gear, opens/closes the tip-end portion of the other clamp by rotating a spar gear meshed with the wheel in conjunction with the rotation of the wheel, and opens or closes the both tip-end portions of the pair of clamps. By means of this opening/closing mechanism, co-rotation can be reliably prevented with a simple mechanism. Moreover, the rotation preventing jig can sandwich the sliding component or the fixed component with different sizes. Furthermore, the rotation preventing jig can also reliably sandwich the sliding component or the fixed component with variation in dimensional accuracy.

Moreover, in the motorization unit for a manual stage, it is preferable that the control knob gripping portion removably grips the knob portion of the control knob by a claw-shaped chuck device. As a result, the knob portion of the control knob can be reliably gripped with a simple mechanism. Moreover, by replacing this chuck mechanism with another chuck mechanism with a different size, the knob portions with various sizes can be handled. Furthermore, the knob portions of the control knobs with variation in dimensional accuracy can be reliably gripped.

In order to achieve the above object, the manual stage according to the present invention is a manual stage in which a sliding component to which a precision device is attached and a fixed component fixed to a base are coupled to each other via a driving mechanism, and the sliding component is moved by rotating operation of a control knob around its shaft in order to perform positional adjustment of the precision device, the manual stage is characterized in that automatic operation is made selectable by attaching a motorization unit provided with a rotation preventing jig for preventing co-rotation by sandwiching the sliding component or the fixed component, a coupling portion for driving the control knob connected to the control knob while holding substantial coaxiality with the control knob shaft, a control knob gripping portion for gripping a knob portion of the control knob, and a motor for rotating the coupling portion for driving the control knob.

By means of the above configuration, in the manual stage to which the motorization unit is removably attached, either one of the manual operation and the automatic operation is freely selected by attaching/removing the motorization unit. As a result, the user can set an automatic operation mode (or the electric operation mode) for an already purchased manual stage. Moreover, by removing the attached motorization unit, the mode can be switched to the manual operation mode, and convenience of use of the stage is improved. Therefore, the user can use the unit by separately utilizing a merit of the manual operation and a merit of the automatic operation or the electric operation, respectively.

This motorization unit is composed of the rotation preventing jig, the coupling portion for driving the control knob, the control knob gripping portion, and the motor. Co-rotation can be prevented by the rotation preventing jig sandwiching the sliding component or the fixed component of the manual stage. Moreover, the rotation preventing jig can sandwich the sliding component or the fixed component with different sizes. Moreover, the control knob can be connected by the coupling portion for a control knob while holding substantial coaxiality with the control knob axis. Furthermore, the control knob gripping portion can reliably grip a knob portion of the control knob with variation in dimensional accuracy.

Moreover, in the manual stage, it is preferable that manual rotating operation of the coupling portion for driving the control knob of the attached motorization unit rotates the knob portion of the control knob gripped by the control knob gripping portion so as to perform fine adjustment of a position of the precision device. As a result, in addition to the above-described manual operation and automatic operation, the control knob can be finely adjusted manually by the coupling portion for driving the control knob by stopping the automatic operation.

In order to achieve the above object, the motorization unit for a manual stage according to the present invention is attached to a manual stage in which a sliding component to which a precision device is attached and a fixed component fixed to a base are coupled to each other via a driving mechanism, and the sliding component is moved by rotating operation of a control knob around its shaft in order to perform positional adjustment of the precision device. The motorization unit is provided with sandwiching/fixing portions for sandwiching and fixing the sliding component or the fixed component, a motorization unit main body connected to the control knob of the sliding component or the fixed component while holding substantial coaxiality with the control knob shaft, and a motor for rotating the control knob, and characterized in that either one of the manual operation and the automatic operation is selected by attaching/removing the unit.

By means of the above configuration, the motorization unit is removably attached to the manual stage. Then, either one of the manual operation and the automatic operation is selected by attaching/removing the motorization unit. As a result, the user can set an automatic operation mode (or an electric operation mode) by attaching a newly purchased motorization unit to an already purchased manual stage. Moreover, by removing the attached motorization unit, the mode can be returned to the manual operation mode, and convenience of use of the stage is improved. Therefore, the user can use the unit by separately utilizing a merit of the manual operation and a merit of the automatic operation or the electric operation, respectively.

This motorization unit is composed of the sandwiching/fixing portions for sandwiching and fixing the sliding component or the fixed component, the motorization unit main body coupled to the control knob of the sliding component or the fixed component while holding substantial coaxiality with the control knob shaft, and the motor for rotating the control knob. Co-rotation can be prevented by the sandwiching/fixing portions for fixing the sliding component or the fixed component of the manual stage. Moreover, the sandwiching/fixing portions can also sandwich the sliding component or the fixed component with different sizes. Moreover, the sandwiching/fixing portions can also reliably sandwich the sliding component or the fixed component with variation in dimensional accuracy. Moreover, the control knob can be connected by the motorization unit main body while holding substantial coaxiality with the control knob shaft. Furthermore, the motorization unit main body can reliably grip the knob portion of the control knob with variation in dimensional accuracy.

Moreover, in the motorization unit for a manual stage, it is preferable that the sandwiching/fixing portions are in the form of a frame composed of a sandwiching plate having a bolt hole and a through bolt, the sliding component or the fixed component is sandwiched by the frame from the both sides, and the sliding component or the fixed component is tightened by tightening a nut. As a result, co-rotation can be reliably prevented with a simple mechanism. Moreover, this frame can also sandwich the sliding component or the fixed component with different sizes.

Moreover, in the motorization unit for a manual stage, it is preferable that the motorization unit main body has a fine adjustment knob for manually rotating the control knob while holding substantial coaxiality with the control knob shaft of the sliding component or the fixed component. As a result, in addition to the above-described manual operation and automatic operation, the control knob can be finely adjusted manually by the coupling portion for driving the control knob by stopping the automatic operation mode.

Moreover, in the motorization unit for a manual stage, it is preferable that the control knob shaft in which the knob portion has been removed from the control knob is coupled to the motorization unit main body. As a result, the control knob can be rotated with a simple mechanism. Moreover, instead of the knob portion of the control knob with relatively poor dimensional accuracy, the control knob shaft with relatively good dimensional accuracy can be gripped.

In order to achieve the above object, the manual stage according to the present invention is a manual stage in which a sliding component to which a precision device is attached and a fixed component fixed to a base are coupled to each other via a driving mechanism, and the sliding component is moved by rotating operation of a control knob around its shaft in order to perform positional adjustment of the precision device, characterized in that automatic operation can be made selectable by attaching a motorization unit provided with sandwiching/fixing portions for sandwiching and fixing the sliding component or the fixed component, a motorization unit main body coupled to the control knob of the sliding component or the fixed component while holding substantial coaxiality with the control knob shaft, and a motor for rotating the control knob.

By means of the above configuration, the motorization unit is removably attached to the manual stage, and either one of the manual operation and the automatic operation is selected by attaching/removing the unit. As a result, the user can make an already purchased manual stage an electric stage by attaching the newly purchased motorization unit. Moreover, the user can return the stage to the manual stage by removing the attached motorization unit, which improves convenience of use. Moreover, the user can use the stage by separately utilizing the merit of the manual operation and the merit or the electric operation, respectively.

Moreover, in the manual stage, it is preferable that the attached motorization unit main body has a fine adjustment knob for manually rotating the control knob while holding substantial coaxiality with the control knob shaft of the sliding component or the fixed component. As a result, in addition to the manual operation and the automatic operation described above, the control knob can be finely adjusted manually by using the fine adjustment knob by stopping the automatic operation.

In order to achieve the above object, the motorization unit for a manual stage according to the present invention is attached to a feed-screw type manual stage in which a sliding component to which a precision device is attached and a fixed component fixed to a base are coupled to each other via a driving mechanism, and the sliding component is moved by rotating operation of a control knob around its shaft in order to perform positional adjustment of the precision device, provided with a control knob gripping portion for gripping a knob portion of the control knob, a coupling portion for driving the control knob coupled to the control knob of the sliding component or the fixed component while holding substantial coaxiality with the control knob shaft, a motor for rotating the coupling portion for driving the control knob, a rotation preventing jig for preventing co-rotation of the motor, and a motor connecting portion connected to the motor and to which the rotation preventing jig is attached, and characterized in that either one of the manual operation and the automatic operation is selected by attaching/removing the unit.

By means of the above configuration, the motorization unit is removably attached to the manual stage. Then, either one of the manual operation and the automatic operation is selected by attaching/removing the motorization unit. As a result, the user can set an automatic operation mode (or an electric operation mode) by attaching a newly purchased motorization unit to an already purchased manual stage. Moreover, by removing the attached motorization unit, the mode can be returned to the manual operation mode, and convenience of use of the stage is improved. Therefore, the user can use the unit by separately utilizing a merit of the manual operation and a merit of the automatic operation or the electric operation, respectively.

This motorization unit is composed of the rotation preventing jig, the coupling portion for driving the control knob, the control knob gripping portion, the motor, and the motor connecting portion. This motor connecting portion couples the motor to the rotation preventing jig. Moreover, the rotation preventing jig is coupled to the manual stage so as to prevent co-rotation of the motor. Moreover, by means of the coupling portion for driving the control knob, the control knob shaft and a motor shaft are interlocked while holding substantial coaxiality. Furthermore, the control knob gripping portion can reliably grip the knob portion of the control knob with variation in dimensional accuracy.

Moreover, in the motorization unit for a manual stage, it is preferable that the rotation preventing jig is a coupling shaft to be fitted into each of a plurality of fixing holes provided in a block on an end portion of the fixed component of the feed-screw type manual stage. Therefore, by inserting at least two coupling shafts into the feed-screw type manual stage by using the fixed holes provided in general, co-rotation of the motor can be easily prevented.

Moreover, in the motorization unit for a manual stage, it is preferable that manual rotating operation of the control knob gripping portion rotates the knob portion of the control knob gripped by the control knob gripping portion so as to perform fine adjustment of a position of the precision device. As a result, the user can manually perform fine adjustment of the control knob by stopping use of the motor and rotating the control knob gripping portion.

Moreover, in the motorization unit for a manual stage, it is preferable that the coupling portion for driving the control knob is combined with the control knob gripping portion so as to integrally interlock the control knob shaft and the motor shaft with each other. As a result, by rotating the control knob gripping portion, rotation of the motor can be reliably linked with rotation of the control knob.

In order to achieve the above object, the manual stage according to the present invention is a feed-screw type manual stage in which a sliding component to which a precision device is attached and a fixed component fixed to a base are coupled to each other via a driving mechanism, and the sliding component is moved by rotating operation of a control knob around its shaft in order to perform positional adjustment of the precision device, characterized in that the automatic operation is made selectable by attaching the motorization unit provided with the control knob gripping portion for gripping the knob portion of the control knob, the coupling portion for driving the control knob coupled to the control knob of the sliding component or the fixed component while holding substantial coaxiality with the control knob shaft, the motor for rotating the coupling portion for driving the control knob, the rotation preventing jig for preventing co-rotation of the motor, and the motor connecting portion connected to the motor and to which the rotation preventing jig is attached.

By means of the above configuration, the manual stage is removably attached to the manual stage, and either one of the manual operation and the automatic operation is selected by attaching/removing the unit. As a result, the user can make an already purchased manual stage an electric stage by attaching the newly purchased motorization unit. Moreover, the user can return the stage to the manual stage by removing the attached motorization unit, which improves convenience of use. Moreover, the user can use the stage by separately utilizing the merit of the manual operation and the merit or the electric operation, respectively.

Moreover, it is preferable that the manual stage is characterized in that manual rotating operation of the control knob gripping portion of the attached motorization unit rotates the knob portion of the control knob gripped by the control knob gripping portion so as to perform fine adjustment of a position of the precision device. As a result, the user can manually perform fine adjustment of the control knob by stopping use of the motor and by rotating the control knob gripping portion.

In order to achieve the above object, the motorization unit for a manual stage according to the present invention is attached to a feed-screw type manual stage in which a sliding component to which a precision device is attached and a fixed component fixed to a base are coupled to each other via the driving mechanism, and the sliding component is moved by rotating operation of the control knob around its shaft in order to perform positional adjustment of the precision device, provided with the coupling portion for driving the control knob coupled to the control knob of the sliding component or the fixed component while holding coaxiality with the control knob shaft, a motor for rotating the coupling portion for driving the control knob, a rotation preventing portion for preventing co-rotation of the motor, and a motor connecting portion connected to the motor, and characterized in that either one of the manual operation and the automatic operation is selected by attaching/removing the unit.

By means of the above configuration, the motorization unit is removably attached to the manual stage. And either one of the manual operation and the automatic operation is selected by attaching/removing the motorization unit. As a result, the user can set the automatic operation mode (or the electric operation mode) by attaching the newly purchased motorization unit to an already purchased manual stage. Moreover, the user can return the stage to the manual operation mode by removing the attached motorization unit, which improves convenience of use of the stage. Therefore, the user can use the stage by separately utilizing the merit of the manual operation and the merit of the automatic operation or the electric operation, respectively.

This motorization unit is composed of the rotation preventing jig, the coupling portion for driving the control knob, the motor, and the motor connecting portion. This motor connecting portion couples the motor to the rotation preventing jig. Moreover, the rotation preventing jig is coupled to the manual stage so as to prevent co-rotation of the motor. Furthermore, the control knob shaft and the motor shaft are interlocked with each other while holding substantial coaxiality by using the coupling portion for driving the control knob.

Moreover, the motorization unit for a manual stage is preferably fixed by a fastening tool to each of the plurality of fixing holes provided on an end portion of the fixed component of the manual stage. Therefore, by means of fixation by using the fastening tool to the fixing holes generally provided on the feed-screw type manual stage, co-rotation of the motor can be easily prevented.

Moreover, in the motorization unit for a manual stage, it is preferable that manual rotating operation of the coupling portion for driving the control knob rotates the control knob shaft of the manual stage so as to perform fine adjustment of a position of the precision device. As a result, the user can manually perform fine adjustment of the control knob by stopping use of the motor and rotating the coupling portion for driving the control knob.

Moreover, in the motorization unit for a manual stage, it is preferable that the coupling portion for driving the control knob is coupled to the control knob shaft in which the knob portion has been removed from the control knob. As a result, the control knob can be rotated with a simplified mechanism. Moreover, instead of the knob portion of the control knob with relatively poor dimensional accuracy, the control knob shaft with relatively good dimensional accuracy can be rotated.

Moreover, in the motorization unit for a manual stage, it is preferable that the coupling portion for driving the control knob is coupled to the control knob shaft through a coupling shaft coupled to the control knob shaft. As a result, the coupling shaft can be selected conforming to a size of the control knob shaft of the manual stage.

Moreover, in the motorization unit for a manual stage, it is preferable that the rotation preventing portion is formed integrally with the motor connecting portion and a control knob shaft supporting base and sandwiches the coupling portion for driving the control knob. That is, the rotation preventing portion and the motor connecting portion are fixed. Moreover, the control knob shaft is reliably held by the control knob shaft supporting base. As a result, the motor connecting portion and the rotation preventing portion are reliably connected to the motor and then, co-rotation of the motor can be prevented.

In order to achieve the above object, the manual stage according to the present invention is a feed-screw type manual stage in which a sliding component to which a precision device is attached and a fixed component fixed to a base are coupled to each other via a driving mechanism, and the sliding component is moved by rotating operation of a control knob around its shaft in order to perform positional adjustment of the precision device, characterized in that the automatic operation is made selectable by attaching the motorization unit provided with the coupling portion for driving the control knob coupled to the control knob of the sliding component or the fixed component while holding substantial coaxiality with the control knob shaft, the motor for rotating the coupling portion for driving the control knob, the rotation preventing portion for preventing co-rotation of the motor, and the motor connecting portion connected to the motor.

By means of the above configuration, the motorization unit is removably attached to the manual stage, and either one of the manual operation and the automatic operation is selected by attaching/removing the unit. As a result, the user can make an already purchased manual stage an electric stage by attaching the newly purchased motorization unit. Moreover, the user can return the stage to the manual stage by removing the attached motorization unit, which improves convenience of use. Moreover, the user can use the stage by separately utilizing the merit of the manual operation and the merit of the electric operation, respectively.

Moreover, in the manual stage, it is preferable that the control knob shaft is rotated by manual rotating operation of the coupling portion for driving the control knob of the attached motorization unit so as to perform fine adjustment of the position of the precision device. As a result, the user can manually perform fine adjustment of the control knob by stopping use of the motor and rotating the control knob gripping portion.

Moreover, in the motorization unit for a manual stage, it is preferable that the sandwiching/fixing portions on the both sides of the sliding component or the fixed component are provided with an elastic body on a side for sandwiching the sliding component or the fixed component, respectively, and push in and fix the sliding component or the fixed component from the both sides by an elastic force of the elastic body. As described above, when the sliding component or the fixed component is sandwiched by the sandwiching/fixing portions on the both sides, the sliding component or the fixed component can be pressed from the both sides with a simple mechanism like an elastic body, and co-rotation can be reliably prevented.

Moreover, in the motorization unit for a manual stage, it is preferable that the sandwiching/fixing portions on the both sides of the sliding component or the fixed component are provided with a spring for coupling the both with each other, and push in and fix the sliding component or the fixed component from the both sides by an elastic force of the spring. As described above, when the sliding component or the fixed component is sandwiched by the sandwiching/fixing portions on the both sides, the sliding component or the fixed component can be pressed from the both sides with a simple mechanism like a spring, and co-rotation can be reliably prevented.

Moreover, in the motorization unit for a manual stage, it is preferable that the motorization unit main body is provided with a fine adjustment knob for manually rotating the control knob while holding substantial coaxiality with the control knob shaft of the sliding component or the fixed component. As a result, in addition to the above-described manual operation and the automatic operation, the control knob can be finely adjusted manually by the coupling portion for driving the control knob by stopping the automatic operation mode.

Moreover, in the motorization unit for a manual stage, it is preferable that the control knob shaft in which the knob portion has been removed from the control knob is coupled to the motorization unit main body. As a result, the control knob can be rotated with a simplified mechanism. Moreover, instead of the knob portion of the control knob with relatively poor dimensional accuracy, the control knob shaft with relatively good dimensional accuracy can be gripped.

Moreover, in the motorization unit for a manual stage, it is preferable that the motorization unit main body is provided with a stopper for preventing removal of the sandwiching/fixing portions. Preferably, this stopper can avoid a situation in which the sandwiching/fixing portions are opened too wide and removed.

Moreover, in the manual stage, it is preferable that the sandwiching/fixing portions on the both sides of the sliding component or the fixed component are provided with an elastic body on a side for sandwiching the sliding component or the fixed component, respectively, and push in and fix the sliding component or the fixed component from the both sides by an elastic force of the elastic body. Thus, when the sliding component or the fixed component is sandwiched by the sandwiching/fixing portions on the both sides, the sliding component or the fixed component can be pressed from the both sides with a simple mechanism like an elastic body, and co-rotation can be reliably prevented.

Moreover, in the manual stage, it is preferable that the sandwiching/fixing portions on the both sides of the sliding component or the fixed component are provided with a spring for coupling the both with each other and push in and fix the sliding component or the fixed component from the both sides by an elastic force of the spring. As described above, when the sliding component or the fixed component is sandwiched by the sandwiching/fixing portions on the both sides, the sliding component or the fixed component can be pressed from the both sides with a simple mechanism like a spring, and co-rotation can be reliably prevented.

Moreover, in the manual stage, it is preferable that the attached motorization unit main body is provided with a fine adjustment knob for manually rotating the control knob while holding substantial coaxiality with the control knob shaft of the sliding component or the fixed component. As a result, in addition to the above-described manual operation and the automatic operation, the control knob can be finely adjusted manually by using the coupling portion for driving the control knob by stopping the automatic operation mode.

### Advantageous Effect of the Invention

As described above, according to the motorization unit for a manual stage and the manual stage with the motorization unit according to the present invention, the automatic operation and the manual operation can be freely selected by removably attaching a simplified mechanism to a prior-art manual stage of moving the sliding component by manual rotation of the control knob, and moreover, the motorization unit for a manual stage and the manual stage with the motorization unit capable also of manual fine adjustment can be provided.

### BRIEF DESCRIPTION OF THE DRAWINGS

FIG. 1 is a perspective view illustrating a schematic configuration of a first embodiment of a motorization unit for a manual stage according to the present invention and is an exploded perspective view illustrating a schematic configuration of a first embodiment of a manual stage with the motorization unit.

FIG. 2 are side views of the motorization unit for a manual stage and the manual stage with the motorization unit in FIG. 1.

FIG. 3 is a perspective view illustrating a schematic configuration of a different second embodiment of a motorization unit for a manual stage according to the present invention and a manual stage with the motorization unit.

FIG. 4 is a plan view of the motorization unit for a manual stage and the manual stage with the motorization unit in FIG. 3.

FIG. 5A is a side view seen from an A-A direction in FIG. 3.

FIG. 5B is a side view seen from a B-B direction in FIG. 3.

FIG. 6 is a plan view and a side view of an X-axis stage which is a target of the present invention.

FIG. 7 is a plan view and a side view of an X-axis stage (an extended control knob type) which is a target of the present invention.

FIG. 8 is a plan view and a side view of an XY-axis stage which is a target of the present invention.

FIG. 9 is a plan view and a side view of a Z-axis stage which is a target of the present invention.

FIG. 10 is a plan view, a bottom view, and a side view of an X-axis stage which is a target of the present invention.

FIG. 11 is a plan view, a bottom view, and a side view of a Z-axis stage which is a target of the present invention.

FIG. 12 is a plan view, a bottom view, and a side view of an X-axis stage which is a target of the present invention.

FIG. 13 is a plan view, a bottom view, and a side view of an X-axis stage (a dovetail groove feed-screw type) which is a target of the present invention.

FIG. 14 is a plan view, a bottom view, and a side view of an X-axis stage (a dovetail groove slim feed-screw type) which is a target of the present invention.

FIG. 15 is a plan view, a bottom view, and a side view of an X-axis stage (a dovetail groove slim feed-screw type) which is a target of the present invention.

FIG. 16 is a plan view, a bottom view, and a side view of an X-axis stage which is a target of the present invention.

FIG. 17 is a perspective view illustrating a schematic configuration of a third embodiment of a motorization unit for a manual stage according to the present invention and is an exploded perspective view illustrating a schematic configuration of a third embodiment of a manual stage with the motorization unit.

FIG. 18 is a perspective view illustrating a configuration of a rotation preventing jig, a motor connecting portion, and a motor of the motorization unit in FIG. 17.

FIG. 19 is a perspective view illustrating a connecting method between a feed-screw type manual stage and a motorization unit.

FIG. 20 is an A-A sectional view (partial) of a manual stage with a motorization unit.

FIG. 21 is a perspective view illustrating a schematic configuration of a fourth embodiment of a motorization unit for a manual stage according to the present invention and a partially exploded perspective view illustrating a schematic configuration of a fourth embodiment of a manual stage with the motorization unit.

FIG. 22 is a perspective view illustrating an entire configuration of the manual stage with the motorization unit illustrated in FIG. 21.

FIG. 23 is a perspective view illustrating a configuration of a motorization unit.

FIG. 24 is a perspective view illustrating a connecting method between a feed-screw type manual stage and a motorization unit.

FIG. 25 is a B-B sectional view of the manual stage with the motorization unit illustrated in FIG. 22.

FIG. 26 is a perspective view illustrating a schematic configuration of a first example which is a variation of the second embodiment of the motorization unit for a manual stage and the manual stage with the motorization unit according to the present invention.

FIG. 27 is a plan view of the motorization unit for a manual stage and the manual stage with the motorization unit in FIG. 26.

FIG. 28 is a perspective view illustrating a schematic configuration of a second example which is a variation of the second embodiment of the motorization unit for a manual stage and the manual stage with the motorization unit according to the present invention.

FIG. 29 is a plan view of the motorization unit for a manual stage and the manual stage with the motorization unit in FIG. 28.

FIG. 30 is a perspective view of the motorization unit for a manual stage and the manual stage with the motorization unit in FIG. 28 seen from a side of the manual stage.

### MODE FOR CARRYING OUT THE INVENTION

### Configuration of a First Embodiment of Motorization Unit for Manual Stage

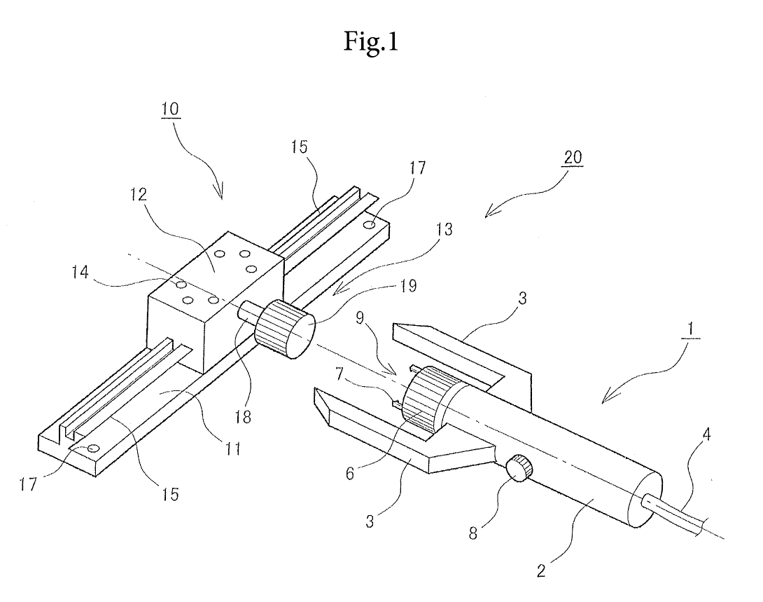

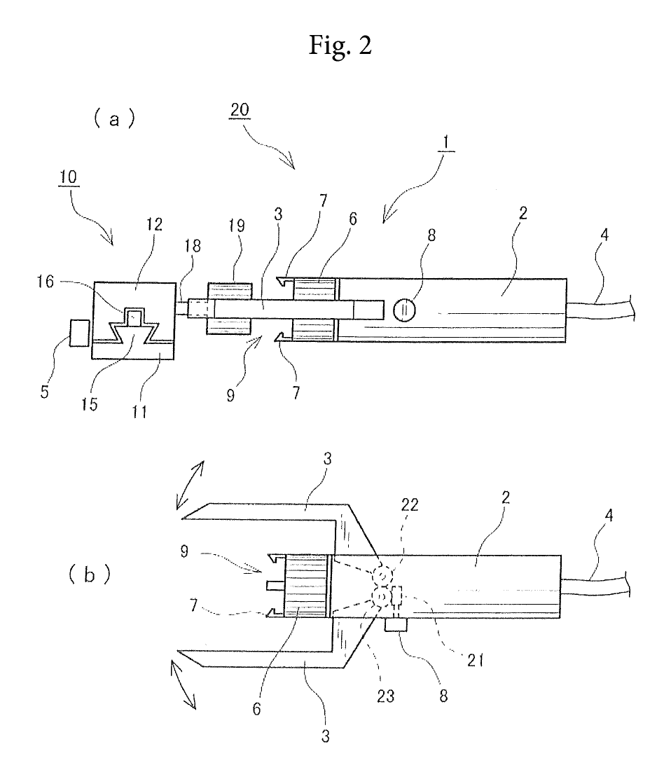

A first embodiment of a motorization unit 1 for a manual stage according to the present invention will be described below in detail with reference to the attached drawings. FIG. 1 illustrates a perspective view of a schematic configuration of the first embodiment of the motorization unit 1 for a manual stage. The motorization unit 1 for a manual stage is attached to a manual stage 10, and a function of an automatic stage is exerted in the manual stage 10. Further, FIG. 2 illustrates a side view of the motorization unit 1 for a manual stage in FIG. 1.

In the manual stage 10, a sliding component 12 is coupled to a fixed component 11 via a driving mechanism such as a rack-and-pinion type, a feed-screw type and the like, for example. FIG. 1 illustrates a case in which the manual stage is of the rack-and-pinion type in which the a rack 15 and a pinion gear 16 (see FIG. 2) are meshed with each other and slide, but other manual stages such as a feed-screw type, for example, may be used. In the case of the manual stage 10 illustrated in FIG. 1, a control knob 13 and a control knob portion 19 are attached to the sliding component 12. Then, by means of rotation of the control knob 13, the pinion gear 16 coupled to the sliding component 12 rotates and moves on the rack 15 attached to the fixed component. It should be noted that, if the control knob 13 is attached to the fixed component 11, the pinion gear 16 coupled to the fixed component 11 rotates by rotation of the control knob 13 and moves on the rack 15 attached to the sliding component 12. A user of the manual stage 10 performs rotating operation of the control knob portion 19 around its axis and moves the sliding component 12 with respect to the fixed component 11 so as to perform positional adjustment of a precision device. Moreover, the manual stage 10 fixes the sliding component 12 at an arbitrary position on the fixed component 11 by tightening of a sliding lock screw 5 illustrated in FIG. 2. Then, by loosening the sliding lock screw 5, the sliding component 12 is made movable. Moreover, the precision device (not shown) is attached to a precision device mounting hole 14 by a fastening tool. Furthermore, the fixed component 11 is fixed to a base (not shown) by screwing the fastening tool into a base fixing hole 17.

A motorization unit 1 for a manual stage according to the present invention is a unit attached to this manual stage 10 and electrically drives movement of the sliding component 12 of the manual stage 10. As illustrated in FIG. 1, this motorization unit 1 is composed of a clamp 3 which is a rotation preventing jig, a coupling 9 which is a coupling portion for driving the control knob, a coupling claw 7 which is a control knob gripping portion, and a motor (not shown) embedded in a motorization unit main body 2. Moreover, a wire harness 4 bundling wires is attached to the motorization unit main body 2. The manual stage 10 includes, for example, a dovetail groove type stage, a feed-screw type stage, a linear-ball type stage, a cross-roller type stage, a simplified ball type stage, a dovetail groove slide-rail type stage and the like depending on the sliding mechanism, but the motorization unit 1 of the present invention is applied to any type of the manual stage 10 to which the motorization unit 1 can be attached in the above-described manual stages 10 other than the dovetail groove type stage and the feed-screw type stage.

The clamp 3 sandwiches the sliding component 12 or the fixed component 11 of the manual stage 10 from both sides, generates a reaction force against a torque generated by rotation of the motor and prevents co-rotation of the motorization unit 1. Moreover, the coupling 9 is connected to the control knob 13 while holding substantial coaxiality with a control knob shaft 18. Then this coupling 9 is rotated by the motor (not shown). Moreover, the coupling claw 7 grips the knob portion 19 of the control knob 13 and transmits rotation of the coupling 9 to the control knob 13. In this coupling claw 7, “claw” shaped chuck devices are provided so as to sandwich and to removably grip the knob portion 19 of the control knob 13.

As illustrated in FIG. 2, this clamp 3 becomes an opening/closing mechanism for removably sandwiching the sliding component 12 or the fixed component 11 by mutually opening or closing the tip-end portions. This opening/closing mechanism rotates a coupled wheel 23 by rotating a gear 21 around its axis by using a clamp opening/closing screw 8 and opens/closes the tip-end portion of one of the clamps 3. Moreover, a spar gear 22 meshed with the wheel 23 is rotated in conjunction with the rotation of the wheel 23 so as to open/close the tip-end portion of the other clamp 3. A direction of opening/closing and a degree of opening/closing of the tip-end portions of this pair of clamps 3 are adjusted by a rotation direction and a rotation amount of the clamp opening/closing screw 8 provided on the motorization unit main body 2. As described above, by mutually opening or closing the tip-end portions of the pair of clamps 3, the sliding component 12 or the fixed component 11 can be sandwiched simply. Moreover, this opening/closing mechanism can also sandwich the sliding component 12 or the fixed component 11 with different sizes. Moreover, this opening/closing mechanism can also reliably sandwich the sliding component 12 or the fixed component 11 with variation in dimensional accuracy.

The coupling 9 is a mechanism to be connected to the control knob 13 and is provided with a knurling tool 6 which is a knob portion on an outer periphery of its circular shape. In a state in which the coupling claw 7 grips the knob portion 19 of the control knob 13, by manual rotating operation of the knurling tool 6, the knob portion 19 of the control knob 13 is rotated, and fine adjustment of the position of the precision device can be performed.

As described above, the motorization unit 1 for a manual stage according to the present invention can be removably attached to the manual stage 10. Moreover, by attaching the motorization unit 1 to the manual stage 10, the mode is switched to the automatic operation mode (or the electric operation mode). Moreover, by removing the motorization unit 1 from the manual stage 10, the mode is switched to the manual operation mode. That is, either one of the manual operation and the automatic operation is selected by the motorization unit 1 for a manual stage according to the present invention. Moreover, even in the automatic operation mode (or the electric operation mode) in which the motorization unit 1 is attached to the manual stage 10, the position of the precision device can be finely adjusted by manually rotating the knurling tool 6. As a result, the merit of the manual operation mode can be exerted in the automatic operation mode (or the electric operation mode).

### Configuration of a Second Embodiment of the Motorization Unit for Manual Stage

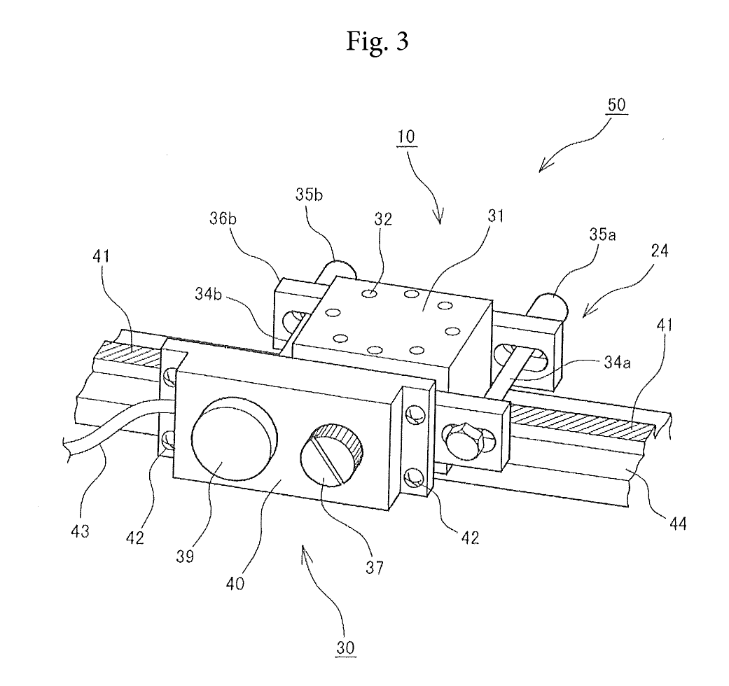

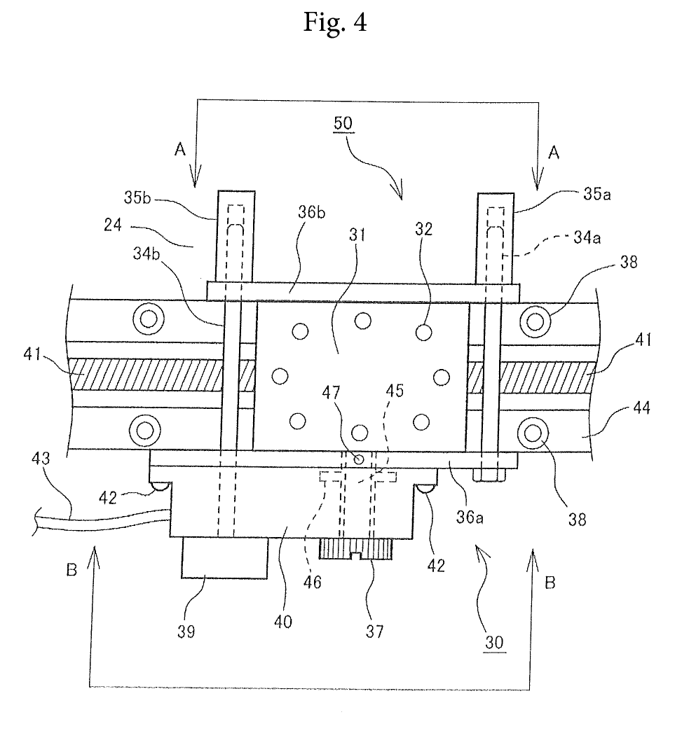

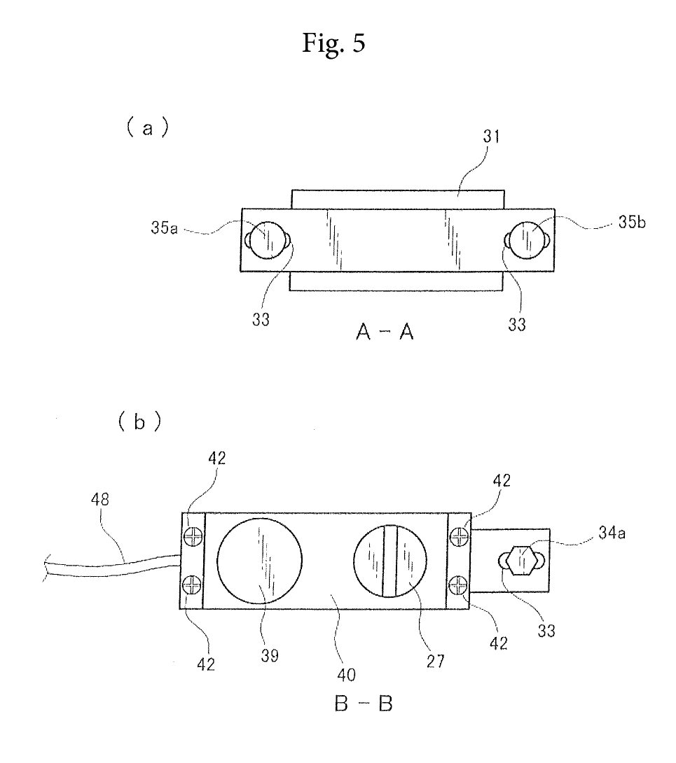

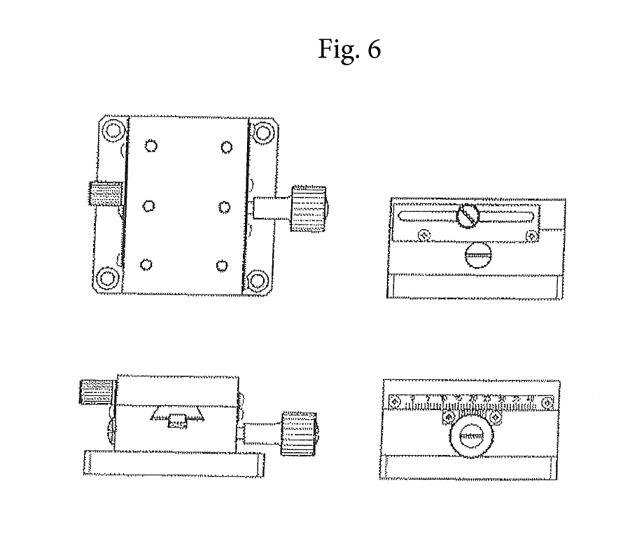

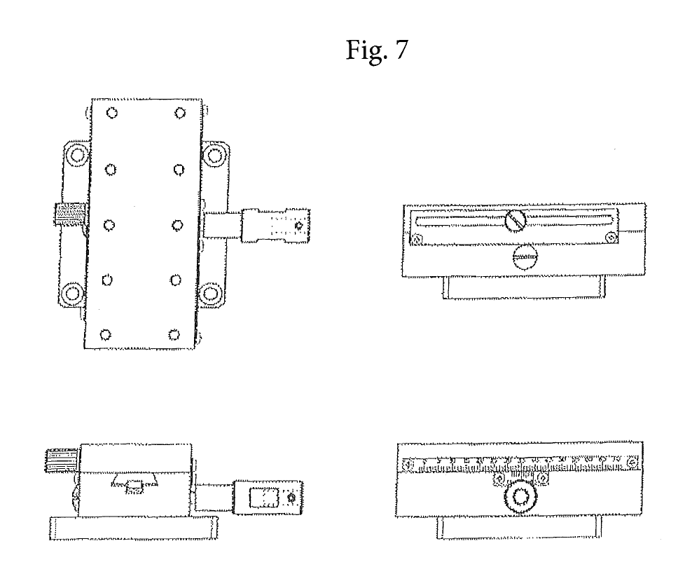

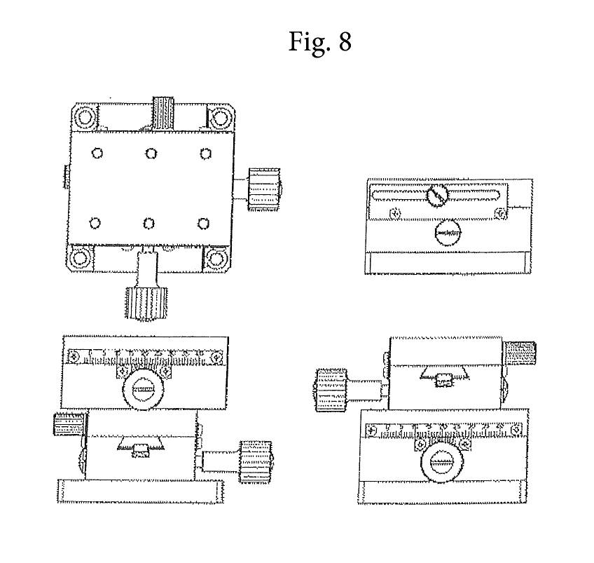

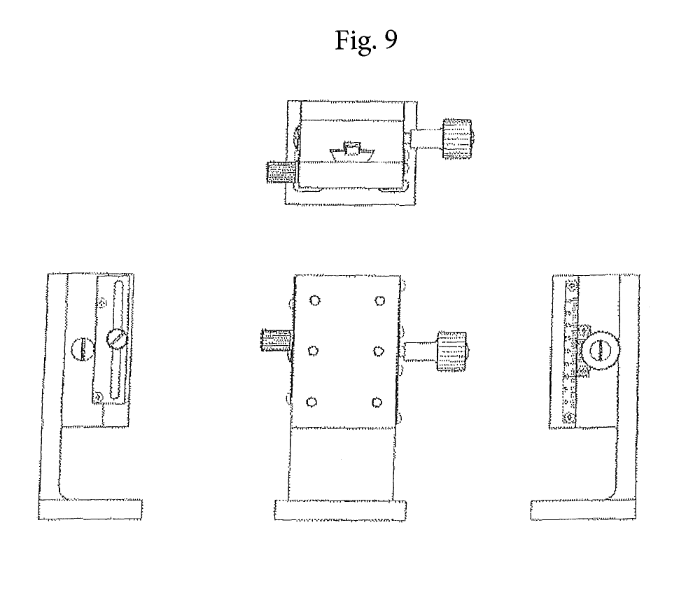

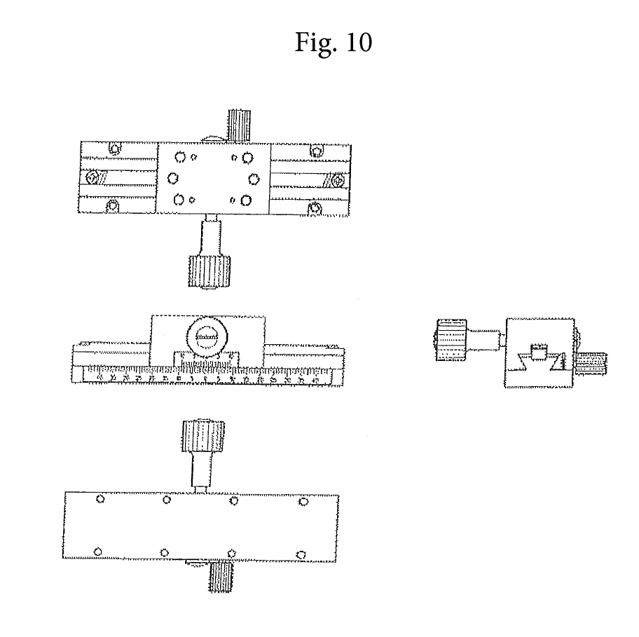

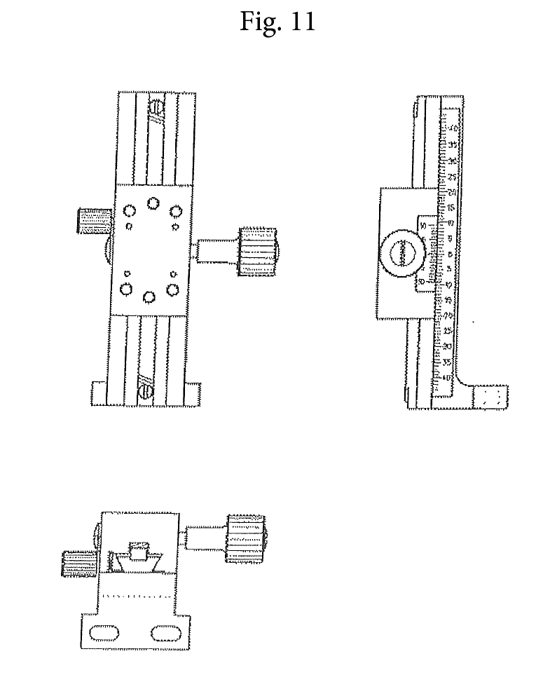

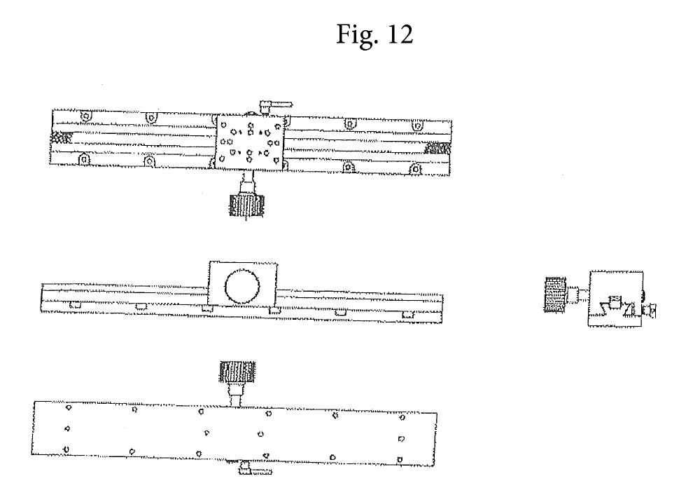

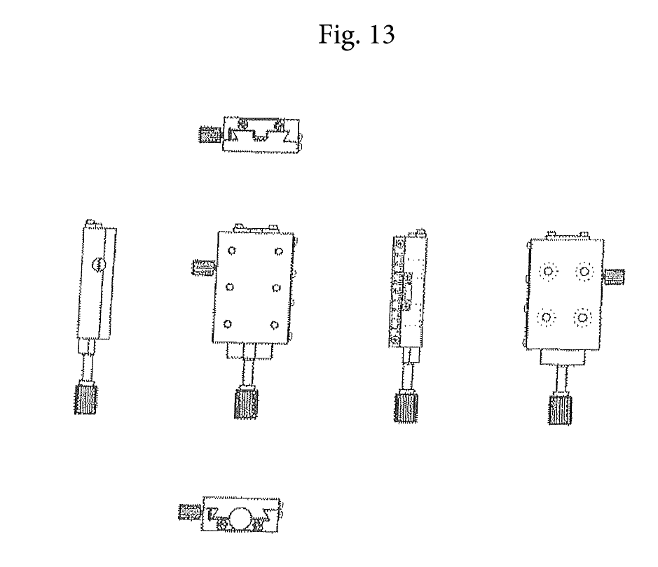

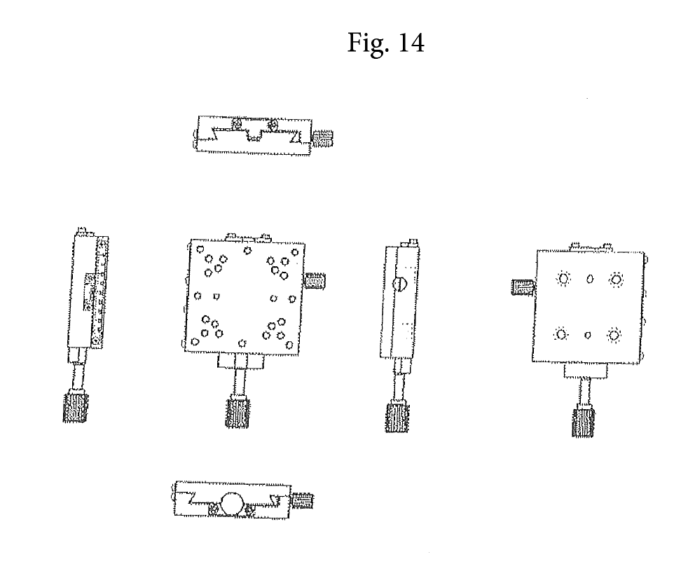

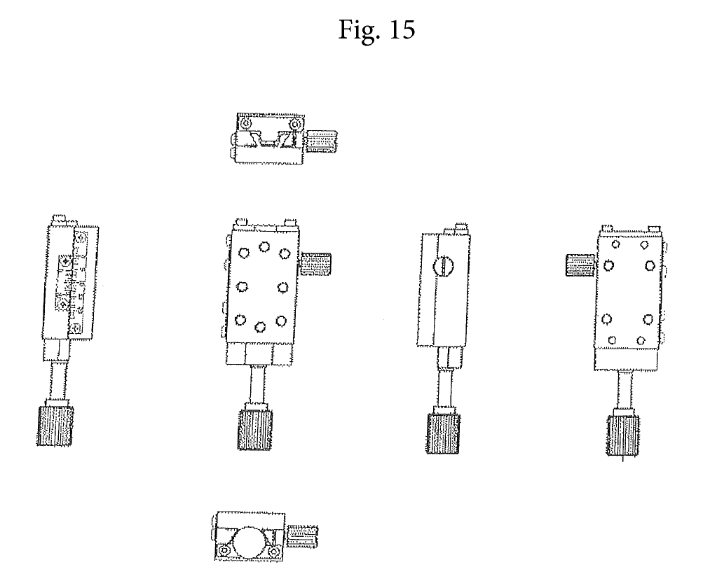

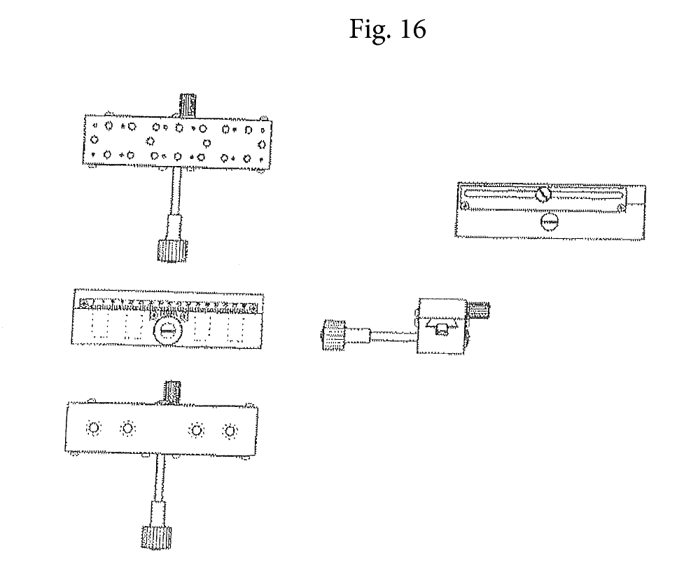

A second embodiment of a motorization unit 30 for a manual stage according to the present invention will be described below in detail with reference to the attached drawings. FIG. 3 illustrates a schematic configuration of the second embodiment of the motorization unit 30 for a manual stage in a perspective view. The motorization unit 30 for a manual stage is attached to the manual stage 10, and the function of the automatic stage is exerted in the manual stage 10. Moreover, FIG. 4 illustrates a plan view of the motorization unit 30 for a manual stage in FIG. 3. Furthermore, FIG. 5 illustrates a side view of the motorization unit 30 for a manual stage in FIG. 4.

In the manual stage 10, the sliding component 31 is coupled to the fixed component 44 via a driving mechanism such as a rack-and-pinion, a feed screw and the like, for example. FIG. 3 illustrates a case of the rack-and-pinion type manual stage in which a rack 41 and a pinion gear (not shown) are meshed with each other and slide. The motorization unit 30 for a manual stage according to the present invention is a unit attached to this manual stage 10 and electrically drives movement of the sliding component 31 or the fixed component 44 of the manual stage 10. It should be noted that the manual stage 10 includes, for example, a dovetail groove type stage, a feed-screw type stage, a linear-ball type stage, a cross-roller type stage, a simplified ball type stage, a dovetail groove slide-rail type stage and the like depending on the sliding mechanism, but the manual stage 10 of the present invention is applied to any type of the manual stage 10 to which the motorization unit 30 can be attached in the above-described manual stages 10 other than the dovetail groove type stage and the feed-screw type stage.

As illustrated in FIGS. 3 and 4, this motorization unit 30 is composed of sandwiching/fixing portions 24 for sandwiching and fixing the sliding component 31 or the fixed component 44, a motorization unit main body 40 to be coupled to a control knob of the sliding component 31 or the fixed component 44 while holding substantial coaxiality with a control knob shaft 45, and a motor (not shown) for rotating the control knob. Moreover, a wire harness 43 which bundles wires is attached to the motorization unit main body 40.

The sandwiching/fixing portions 24 are composed of a sandwiching plate 36a provided on a front surface of the sliding component 31 or the fixed component 44 and between that and the motorization unit main body 40, a sandwiching plate 36b provided on a rear surface of the sliding component 31 or the fixed component 44, through bolts 34a and 34b coupling the sandwiching plates 36a and 36b, and cap nuts 35a and 35b connected to the through bolts 34a and 34b, and a frame is constituted. The motorization unit main body is connected to the sandwiching plate 36a by a mounting bolt 42. By means of tightening the cap nuts 35 of this frame and a through-bolt tightening screw 39 provided on the motorization unit main body 40, the motorization unit main body 40 is connected to the sliding component 31 or the fixed component 44 in close contact. Then, co-rotation can be reliably prevented by this frame with a simple mechanism. Moreover, the sliding component or the fixed component with different sizes can be also sandwiched.

As illustrated in FIG. 4, the control knob shaft 45 in which the knob portion has been removed from the control knob is coupled to the motorization unit main body 40. This control knob shaft 45 is rotated electrically by being coupled to a gear 46 in conjunction with the motor (not shown) provided in the motorization unit main body 40. This gear 46 is fixed to the control knob shaft 45 by a set screw 47. Moreover, the motorization unit main body 40 has a fine-adjustment knob 37 for manually rotating the control knob while holding substantial coaxiality with the control knob shaft 45 of the sliding component 31 or the fixed component 44. By manually rotating this fine-adjustment knob 37, the control knob shaft 45 of the sliding component 31 or the fixed component 44 is rotated in conjunction with the fine-adjustment knob.

As described above, the motorization unit main body 40 rotates the control knob shaft 45 by the gear 46. As a result, the motorization unit main body 40 can be connected to the control knob while holding substantial coaxiality with the control knob shaft 45. Moreover, the motorization unit main body 40 can reliably transmit the rotation of the motor to the manual stage 10 by directly gripping the control knob shaft 45 instead of the knob portion of the control knob with variation in dimensional accuracy.

As described above, the motorization unit 30 for a manual stage according to the present invention can be removably attached to the manual stage 10. Then, by attaching the motorization unit 30 to the manual stage 10, the mode is switched to the automatic operation mode (or the electric operation mode). Moreover, by removing the motorization unit 30 from the manual stage 10, the mode is switched to the manual operation mode. That is, either one of the manual operation and the automatic operation is selected by the motorization unit 30 for a manual stage according to the present invention. Moreover, even in the automatic operation mode (or the electric operation mode) in which the motorization unit 30 is attached to the manual stage 10, a position of the precision device can be finely adjusted by manually rotating the fine-adjustment knob 37. As a result, the merit of the manual operation mode can be exerted in the automatic operation mode.

### Configuration of a First Embodiment of Manual Stage with Motorization Unit

A first embodiment of a manual stage 20 with a motorization unit according to the present invention will be described below in detail with reference to the attached drawings. FIG. 1 illustrates the first embodiment of the manual stage 20 with a motorization unit in an exploded perspective view. The manual stage 20 with a motorization unit is a stage in which the motorization unit 1 for a manual stage is connected to the manual stage 10 in a direction indicated by a one-dot chain line in FIG. 1. Moreover, FIG. 2 illustrates a side view of the manual stage 20 with the motorization unit in FIG. 1.

It should be noted that the manual stage 10 includes, for example, a dovetail groove type stage, a feed-screw type stage, a linear-ball type stage, a cross-roller type stage, a simplified ball type stage, a dovetail groove slide-rail type stage and the like depending on the sliding mechanism, but the manual stage 10 of the present invention is applied to any type of the manual stage 10 to which the motorization unit 1 can be attached in the above-described manual stages 10 other than the dovetail groove type stage and the feed-screw type stage.

The manual stage 20 with a motorization unit is a device in which the motorization unit 1 is embedded in the manual stage 10. The motorization unit 1 is composed of the clamp 3 which is a rotation preventing jig, the coupling 9 which is a coupling portion for driving the control knob, the coupling claw 7 which is a control knob gripping portion, and the motor (not shown) embedded in the motorization unit main body 2.

As illustrated in FIG. 2, the coupling 9 is provided with the knurling tool 6 which is a knob portion on an outer periphery of its circular shape. In a state in which the coupling claw 7 grips the knob portion 19 of the control knob 13, by manual rotating operation of the knurling tool 6, the knob portion 19 of the control knob 13 is rotated, and fine adjustment of the position of the precision device can be performed.

As described above, the manual stage 20 with a motorization unit enters the automatic operation mode when the motorization unit 1 is attached to the manual stage 10. Moreover, by removing the motorization unit 1 from the manual stage 10, the mode is switched to the manual operation mode. That is, in the manual stage 20 with a motorization unit according to the present invention, either one of the manual operation and the automatic operation (or the electric operation mode) is selected. Moreover, even in the “automatic operation” mode in which the motorization unit 1 is attached to the manual stage 10, by manually rotating the knurling tool 6, the position of the precision device can be finely adjusted. As a result, the merit of the manual operation mode can be exerted in the automatic operation (or the electric operation mode) mode.

### Configuration of a Second Embodiment of Manual Stage with Motorization Unit

A second embodiment of a manual stage 50 with a motorization unit according to the present invention will be described below in detail with reference to the attached drawings. FIG. 3 illustrates the second embodiment of the manual stage 50 with a motorization unit in a perspective view. The manual stage 50 with a motorization unit is a stage in which the motorization unit 30 for a manual stage is connected to the manual stage 10. Moreover, FIG. 4 illustrates a front view of the manual stage 50 with a motorization unit in FIG. 3. Moreover, FIG. 5 illustrates a side view of the manual stage 50 with a motorization unit in FIG. 3.

The motorization unit 30 is composed of the sandwiching/fixing portions 24 for sandwiching and fixing the sliding component 31 or the fixed component 44, the motorization unit main body 40 to be coupled to the control knob of the sliding component 31 or the fixed component 44 while holding substantial coaxiality with the control knob shaft, and the motor (not shown) for rotating the control knob.

The manual stage 10 includes, for example, a dovetail groove type stage, a feed-screw type stage, a linear-ball type stage, a cross-roller type stage, a simplified ball type stage, a dovetail groove slide-rail type stage and the like depending on the sliding mechanism, but the manual stage 10 of the present invention is applied to any type of the manual stage 10 to which the motorization unit 30 can be attached in the above-described manual stages 10 other than the dovetail groove type stage and the feed-screw type stage.

The attached motorization unit main body 40 has the fine-adjustment knob 37 for manually rotating the control knob while holding substantial coaxiality with the control knob shaft of the sliding component 31 or the fixed component 44.

### Control Method of Motorization Unit

A control method of the above-described motorization units 1 and 30 is performed by a control panel (not shown), and not only the operation using a simple ON/OFF switch but also the operation capable of multi-stage (continuously variable) speed instruction using a joy stick or the operation through designation of a movement amount by using a keypad can be used, and an operation method may be designated by a user.

### Configuration of a Third Embodiment of Motorization Unit for Manual Stage

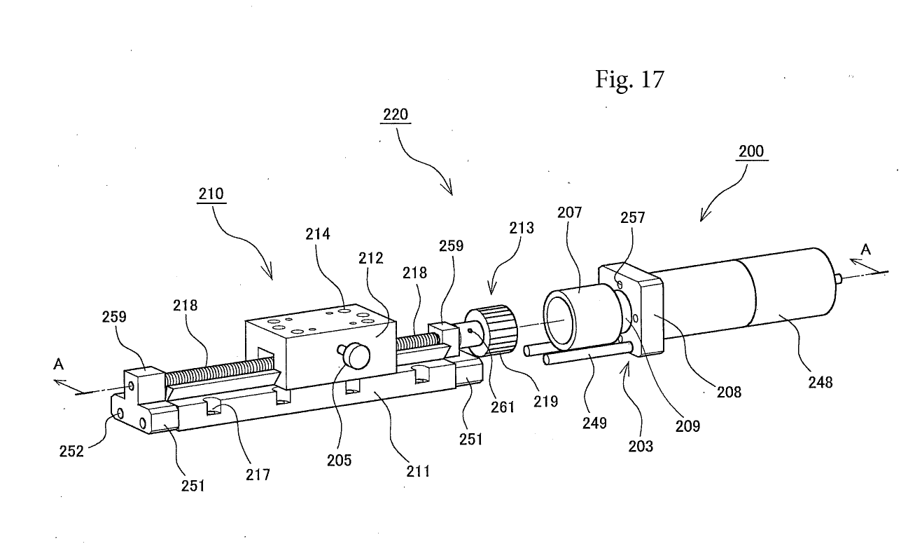

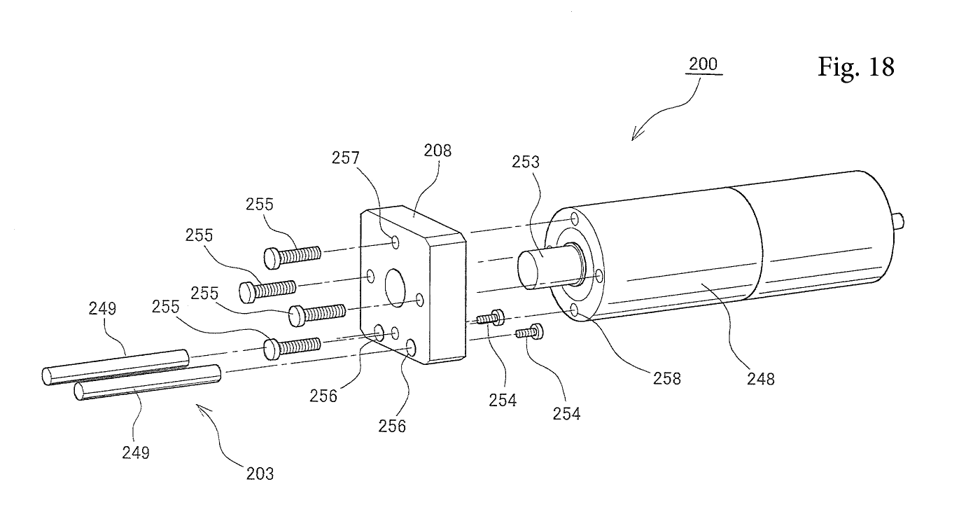

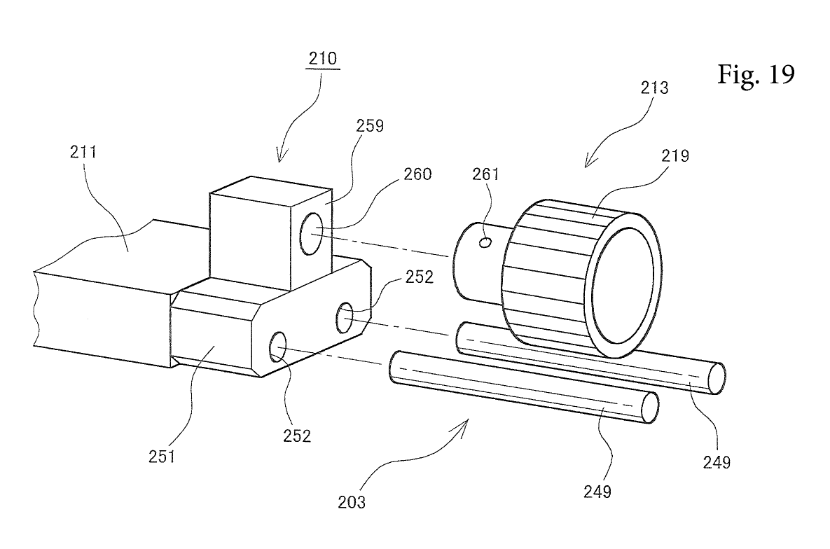

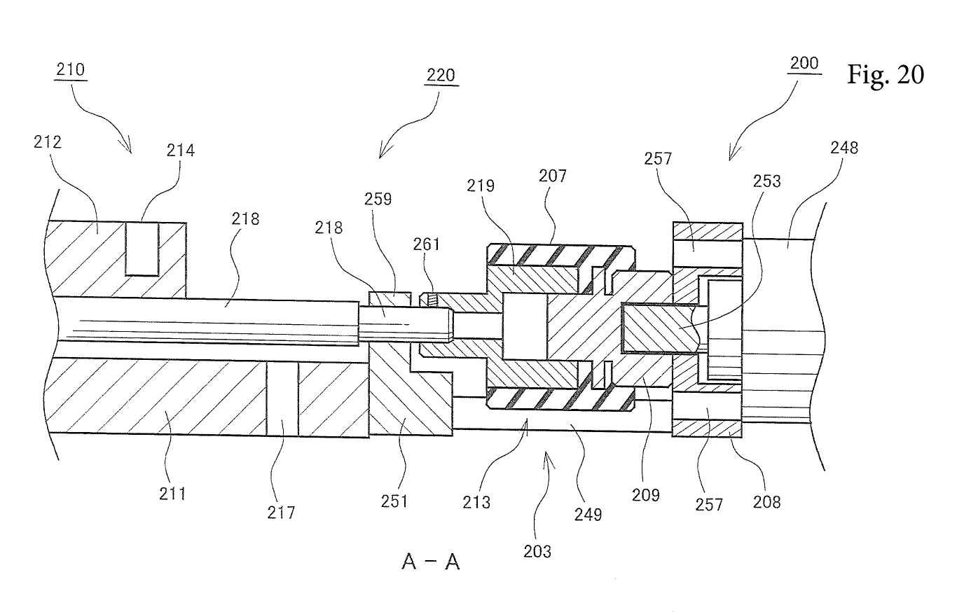

A third embodiment of a motorization unit 200 for a manual stage according to the present invention will be described below in detail with reference to the attached drawings. FIG. 17 illustrates a schematic configuration of the third embodiment of the motorization unit 200 for a manual stage in a perspective view. Moreover, FIG. 18 illustrates configurations of a rotation preventing jig 203, a motor connecting portion 208, and a geared motor 248 of the motorization unit 200 for a manual stage in FIG. 17. Moreover, FIG. 19 illustrates a connecting method between a manual stage 210 and the rotation preventing jig 203 in a perspective view. Furthermore, FIG. 20 illustrates a part of a manual stage 220 with the motorization unit in a sectional view. The motorization unit 200 for a manual stage is attached to the manual stage 210, and a function of the automatic stage is exerted in the manual stage 210.

In the manual stage 210, the sliding component 212 is coupled to the fixed component 211 via a driving mechanism composed of a male thread and a female thread. As illustrated in FIG. 17, in the manual stage 210, a control knob 213 and a control knob portion 219 are attached to a sliding component 212. A user of the manual stage 210 performs rotating operation of the control knob portion 219 around its shaft. A control knob shaft 218 which is a male thread rotates in conjunction with the rotation of this control knob portion 219 and moves the female thread fixed to the sliding component 212. As described above, the positional adjustment of the precision device is performed by moving the sliding component 212 with respect to the fixed component 211. Moreover, the manual stage 210 fixes the sliding component 212 at an arbitrary position on the fixed component 211 by tightening of a sliding lock screw 205 illustrated in FIG. 17. By loosening the sliding lock screw 205, the sliding component 212 is made slidable. Moreover, the precision device (not shown) is mounted to a precision device mounting hole 214 by a fastening tool. Furthermore, the fixed component 211 is fixed to a base (not shown) by screwing the fastening tool into a base fixing hole 217.

The motorization unit 200 for a manual stage according to the present invention is a unit attached to this manual stage 210 and electrically drives movement of the sliding component 212 of the manual stage 210. As illustrated in FIG. 17, this motorization unit 200 is composed of the rotation preventing jig 203 for preventing co-rotation of the motor, a coupling portion 209 for driving the control knob coupled to the control knob 213 of the sliding component 212 or the fixed component211 while holding substantial coaxiality with the control knob shaft 218, a control knob gripping portion 207 for gripping the knob portion 219 of the control knob 213, the geared motor 248 for rotating the coupling portion 209 for driving the control knob, and the motor connecting portion 208 connected to the motor and to which the rotation preventing jig 203 is attached. It should be noted that, in the present invention, the geared motor 248 is used as a motor, but the motor is not limited to this geared motor 248, and any other motors may be used.

It should be noted that the manual stage 210 includes, for example, a dovetail groove stage, a feed-screw stage, a linear-ball type stage, a cross-roller type stage, a simplified ball type stage, a dovetail groove slide-rail type stage and the like depending on the respective sliding mechanism, but the motorization unit 200 of this embodiment is applied to a feed-screw type stage.

As illustrated in FIG. 17, the rotation preventing jig 203 is two coupling shafts 249 in this embodiment. As illustrated in FIG. 18, these coupling shafts 249 are fixed by using coupling shaft fixing screws 254 inserted into coupling shaft fixing holes 256 provided in the motor connecting portion 208. Moreover, the motor connecting portion 208 is fixed to the geared motor 248 by penetration of the motor connecting portion fixing screw 255 through the motor connecting portion fixing hole 257 and fastening to a motor mounting hole 258. Then, as illustrated in FIG. 19, each of the coupling shafts 249 is fitted in fixing holes 252, respectively, provided in a block 251 on an end portion of the fixed component 211 of the manual stage 210. As a result, the geared motor 248 fixed to the motor connecting portion 208 is fixed to the manual stage 210 by the two coupling shafts 249. As a result, the motorization unit 200 is fixed to the manual stage 210 by using these configurations, and co-rotation is prevented without being affected by rotation of a motor shaft 253.

The coupling portion 209 for driving the control knob interlocks the control knob shaft 218 with the motor shaft 253. As illustrated in FIG. 20 in a section, the coupling portion 209 for driving the control knob has one end connected to the motor shaft 253 protruding from the geared motor 248, while a protruding portion on the other end is connected to the control knob shaft 218 of the control knob 213. Then, the coupling portion 209 for driving the control knob is connected coaxially with the control knob shaft 218 and the motor shaft 253 and thus, the rotation of the motor shaft 253 by the geared motor 248 can be made in conjunction with the control knob shaft 218 of the control knob 213.

The control knob gripping portion 207 is combined and integrated with the coupling portion 209 for driving the control knob. Then, it rotates the knob portion 219 of the control knob 213 gripped by the control knob gripping portion 207. Thus, for the control knob gripping portion 207, a material with high friction coefficient such as rubber including an elastomer, for example, is used, but this is not limiting, and a material of metal such as aluminum and the like may be used. Moreover, this control knob gripping portion 207 can perform fine adjustment of a position of the precision device by manual rotating operation.

As described above, the motorization unit 200 for a manual stage according to the present invention can be removably attached to the manual stage 210. And by attaching the motorization unit 200 to the manual stage 210, the mode is switched to the automatic operation mode (or the electric operation mode). Moreover, by removing the motorization unit 200 from the manual stage 210, the mode is switched to the manual operation mode. That is, either one of the manual operation and the automatic operation is selected by the motorization unit 200 for a manual stage according to the present invention. Moreover, even in the automatic operation mode (or the electric operation mode) in which the motorization unit 200 is attached to the manual stage 210, the position of the precision device can be finely adjusted by manually rotating the control knob gripping portion 207. As a result, the merit of the manual operation mode can be exerted in the automatic operation mode (or the electric operation mode).

### Configuration of a Fourth Embodiment of Motorization Unit for Manual Stage

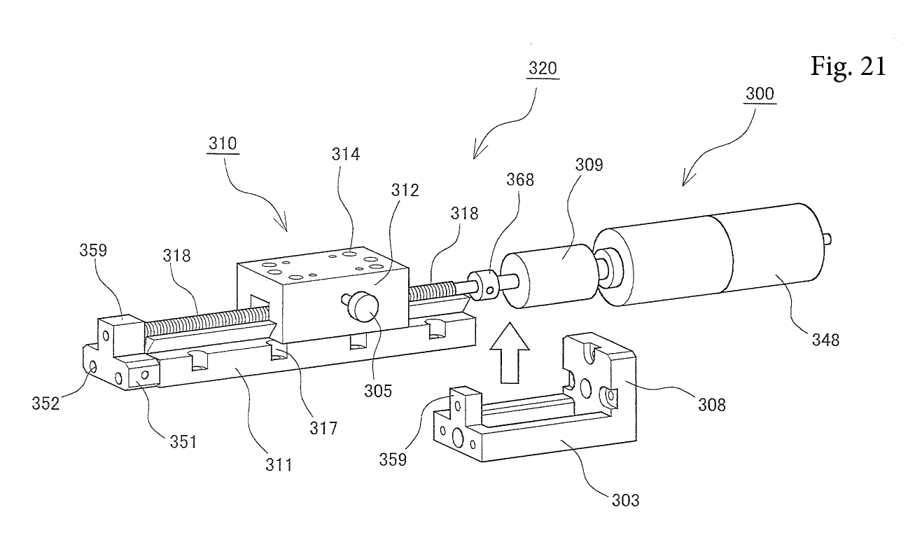

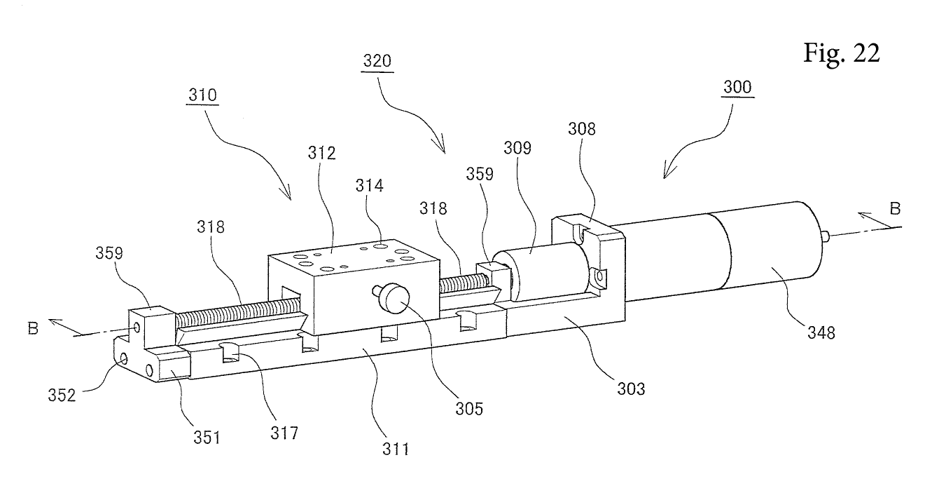

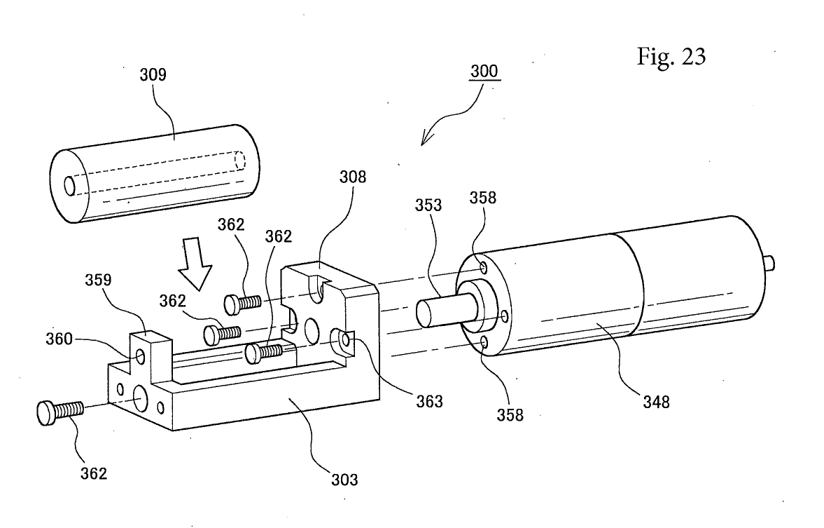

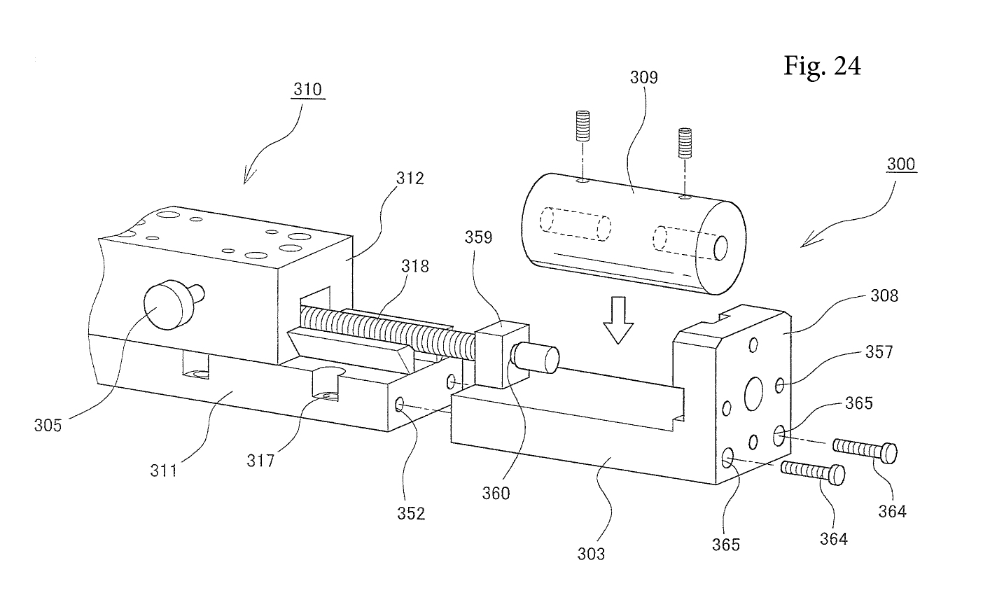

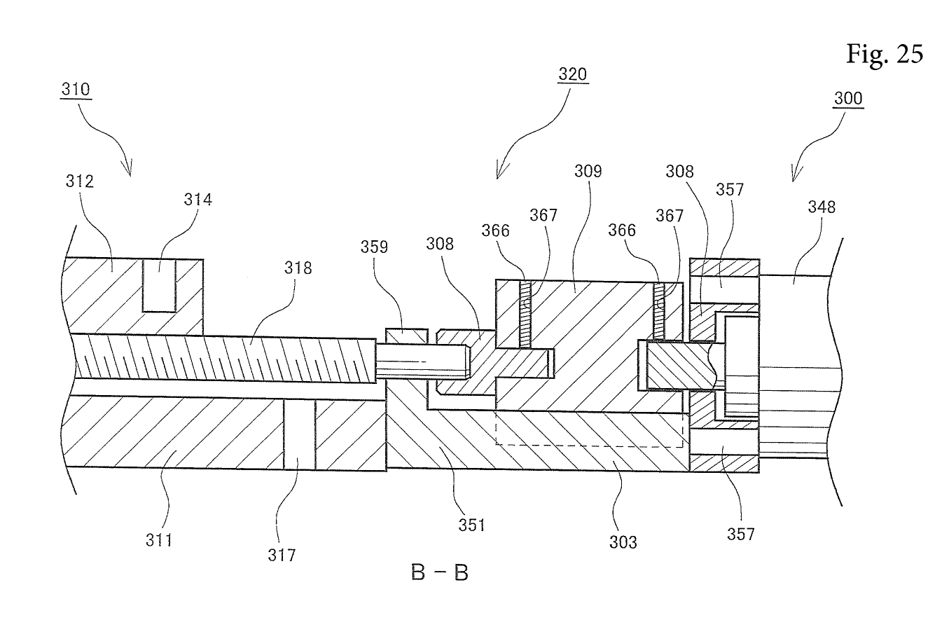

A fourth embodiment of a motorization unit 300 for a manual stage according to the present invention will be described below in detail with reference to the attached drawings. FIG. 21 is a perspective view illustrating a schematic configuration of the fourth embodiment of the motorization unit 300 for a manual stage according to the present invention and is a partially exploded perspective view illustrating a schematic configuration of the fourth embodiment of a manual stage 320 with a motorization unit. Moreover, FIG. 22 is a perspective view illustrating an entire configuration of the manual stage 320 with a motorization unit illustrated in FIG. 21. Moreover, FIG. 23 is a perspective view illustrating a configuration of the motorization unit 300. Moreover, FIG. 24 is a perspective view illustrating a connecting method between a feed-screw type manual stage 310 and the motorization unit 300. Furthermore, FIG. 25 is a B-B sectional view of the manual stage 320 with a motorization unit illustrated in FIG. 22. The motorization unit 300 for a manual stage is attached to the manual stage 310, and a function of the automatic stage is exerted in the manual stage 310.

In the manual stage 310, a sliding component 312 is coupled to a fixed component 311 via a driving mechanism composed of a male screw and a female screw. In the manual stage 310 illustrated in FIG. 21, the control knob (see FIG. 17) and the control knob portion (see FIG. 17) having been attached to the sliding component 312 are detached, and the motorization unit 300 for a manual stage is attached. A user of the manual stage 310 performs rotating operation of the control knob portion 219 around its shaft. A control knob shaft 318 which is a male thread rotates in conjunction with the rotation of this control knob portion 219 and moves the female thread fixed to the sliding component 312. As described above, the positional adjustment of the precision device is performed by moving the sliding component 312 with respect to the fixed component 311. Moreover, the manual stage 310 fixes the sliding component 312 at an arbitrary position on the fixed component 311 by tightening of a sliding lock screw 305 illustrated in FIG. 21. By loosening the sliding lock screw 305, the sliding component 312 is made movable. Moreover, the precision device (not shown) is mounted to a precision device mounting hole 314 by a fastening tool. Furthermore, the fixed component 311 is fixed to a base (not shown) by screwing the fastening tool into a base fixing hole 317.

The motorization unit 300 for a manual stage according to the present invention is a unit attached to this manual stage 310 and electrically drives movement of the sliding component 312 of the manual stage 310. As illustrated in FIG. 21, this motorization unit 300 is composed of a coupling portion 309 for driving the control knob for coupling while holding substantial coaxiality with the control knob shaft 318, a geared motor 348 for rotating the coupling portion 309 for driving the control knob, a rotation preventing portion 303 for preventing co-rotation of the geared motor 348, and a motor connecting portion 308 connected to the geared motor 348. It should be noted that the manual stage 310 includes, for example, a dovetail groove stage, a feed-screw stage, a linear-ball type stage, a cross-roller type stage, a simplified ball type stage, a dovetail groove slide-rail type stage and the like depending on the sliding mechanism, but the motorization unit 300 of this embodiment is applied to a feed-screw type stage.

The coupling portion 309 for driving the control knob interlocks the control knob shaft 318 with a motor shaft 353. As illustrated in FIG. 25 in a section, the coupling portion 309 for driving the control knob has one end connected to the motor shaft 353 protruding from the geared motor 348, while the other end is connected to the control knob shaft 318 of the control knob 313. Then, the coupling portion 309 for driving the control knob is connected coaxially with the control knob shaft 318 and the motor shaft 353 and thus, the rotation of the motor shaft 353 by the geared motor 348 can be made in conjunction with the control knob shaft 318 of the control knob 313.

As illustrated in FIG. 23, the rotation preventing portion 303 is formed integrally with the motor connecting portion 308 and a control knob support base 359, to be in an L-shape. Then, in this L-shape, the coupling portion 309 for driving the control knob can be stably sandwiched. As a result, the compact motorization unit 300 for a manual stage is realized.

Moreover, as illustrated in FIG. 24, the rotation preventing portion 303 is fixed by rotation preventing portion fixing screws 364 to block fixing holes 352 at two spots provided on an end portion of the fixed component 311 of the manual stage 310. The rotation preventing portion fixing screws 364 have their rotation restrained at two spots on the end portion of the fixed component 311 of the manual stage 310. Moreover, as illustrated in FIG. 23, the motor connecting portion 308 penetrates a motor connecting portion fixing hole 363 and is fixed by motor connecting portion fixing screws 362 to a motor mounting hole 358. Three of the motor connecting portion fixing screws 362 penetrate the motor mounting holes 358 provided on the motor connecting portion 308 but one on the lower side penetrates the rotation preventing portion 303 and the motor connecting portion 308. As a result, the rotation preventing portion 303 prevents co-rotation of the moor 348 by means of the configuration fixed to the manual stage 310 and the motor 348.

The coupling portion 309 for driving the control knob is coupled to the control knob shaft 318 in which the knob portion has been removed from the control knob. Then, the coupling portion 309 for driving the control knob is coupled to the control knob shaft 318 through a coupling shaft 368 coupled to the control knob shaft 318. That is, the control knob shaft 318 might have different sizes depending on the model of the manual stage 310. In such a case, it can be connected to the coupling portion 309 for driving the control knob by using the coupling shaft 368 adapted to the control knob shaft 318 of the model of the manual stage 310. As described above, by preparing required coupling shafts 368, different models of the manual stages 310 can be handled. Moreover, the coupling portion 309 for driving the control knob can perform fine adjustment of the position of the precision device by manual rotating operation to rotate the control knob shaft 318 of the manual stage.

As described above, the motorization unit 300 for a manual stage according to the present invention can be removably attached to the manual stage 310. Then, by attaching the motorization unit 300 to the manual stage 310, the mode is switched to the automatic operation mode (or electric operation mode). Moreover, by removing the motorization unit 300 from the manual stage 310, the mode is switched to the manual operation mode. That is, either one of the manual operation and the automatic operation is selected by the motorization unit for a manual stage according to the present invention. Moreover, even in the automatic operation mode (or the electric operation mode) in which the motorization unit 300 is attached to the manual stage 310, the position of the precision device can be finely adjusted by manually rotating the connecting portion 309 for driving the control knob shaft. As a result, the merit of the manual operation mode can be exerted in the automatic operation mode (or the electric operation mode).

### Configuration of a Third Embodiment of Manual Stage with Motorization Unit

A third embodiment of the manual stage 220 with a motorization unit according to the present invention will be described below in detail with reference to the attached drawings. FIG. 17 illustrates the third embodiment of the manual stage 220 with a motorization unit in an exploded perspective view. The manual stage 220 with a motorization unit is a stage in which the motorization unit 200 for a manual stage is connected to the manual stage 210. FIG. 20 illustrates a sectional view of the manual stage 220 with the motorization unit in FIG. 17.

It should be noted that the manual stage 210 includes, for example, a dovetail groove type stage, a feed-screw type stage, a linear-ball type stage, a cross-roller type stage, a simplified ball type stage, a dovetail groove slide-rail type stage and the like depending on the sliding mechanism, but the manual stage 210 of the present invention is applied to the feed-screw type stage.

This manual stage 220 with a motorization unit is a device in which the motorization unit 200 is embedded in the manual stage 210. Then the motorization unit 200 is composed of the rotation preventing jig 203 for preventing co-rotation of the motor, a coupling portion 209 for driving the control knob coupled to the control knob 213 while holding substantial coaxiality with a control knob shaft 218, the control knob gripping portion 207 for gripping the knob portion 219 of the control knob 213, the geared motor 248 for rotating the coupling portion 209 for driving the control knob, and the motor connecting portion 208 connected to the motor and to which the rotation preventing jig 203 is attached.

Moreover, by manual rotating operation of the control knob gripping portion 207 of the attached motorization unit 200, the knob portion 219 of the control knob 213 gripped by the control knob gripping portion 207 is rotated, and fine adjustment of the position of the precision device can be performed.

As described above, the manual stage 220 with a motorization unit enters the automatic operation mode when the motorization unit 200 is attached to the manual stage 210. Moreover, by removing the motorization unit 200 from the manual stage 210, the mode is switched to the manual operation mode. That is, in the manual stage 220 with a motorization unit according to the present invention, either one of the manual operation and the automatic operation (or the electric operation mode) is selected. Moreover, even in the “automatic operation” mode in which the motorization unit 200 is attached to the manual stage 210, by manually rotating the coupling portion 209 for driving the control knob, the position of the precision device can be finely adjusted. As a result, the merit of the manual operation mode can be exerted in the automatic operation (or the electric operation mode) mode.

### Configuration of a Fourth Embodiment of Manual Stage with Motorization Unit

The fourth embodiment of the manual stage 320 with a motorization unit according to the present invention will be described below in detail with reference to the attached drawings. FIG. 22 illustrates the fourth embodiment of the manual stage 320 with a motorization unit in a perspective view. The manual stage 320 with a motorization unit is a stage in which the motorization unit 300 for a manual stage is connected to the manual stage 310. Moreover, FIG. 25 illustrates the manual stage 320 with the motorization unit in a sectional view.

It should be noted that the manual stage 310 includes, for example, a dovetail groove type stage, a feed-screw type stage, a linear-ball type stage, a cross-roller type stage, a simplified ball type stage, a dovetail groove slide-rail type stage and the like depending on the sliding mechanism, but the manual stage 310 of the present invention is applied to the feed-screw type stage.

This manual stage 320 with a motorization unit is a device in which the motorization unit 300 is embedded in the manual stage 310. The motorization unit 300 is composed of the coupling portion 309 for driving the control knob for coupling while holding substantial coaxiality with the control knob shaft 318, the geared motor 348 for rotating the coupling portion 309 for driving the control knob, the rotation preventing portion 303 for sandwiching the coupling portion 309 for driving the control knob and preventing co-rotation, and the motor connecting portion 308 connected to the motor. Moreover, as illustrated in FIG. 21, the coupling portion 309 for driving the control knob may be provided with the coupling shaft 368 to be adapted to a size of the control knob shaft 318. FIG. 22 illustrates a case in which this coupling shaft 368 is not needed.

Moreover, by manual rotating operation of the coupling portion 309 for driving the control knob of the attached motorization unit 300 to rotate the control knob shaft 318, fine adjustment of the position of the precision device can be performed.

As described above, the manual stage 320 with a motorization unit enters the automatic operation mode when the motorization unit 300 is attached to the manual stage 310. Moreover, by removing the motorization unit 300 from the manual stage 310, the mode is switched to the manual operation mode. That is, in the manual stage 320 with a motorization unit according to the present invention, either one of the manual operation and the automatic operation (or the electric operation mode) is selected. Moreover, even in the “automatic operation” mode in which the motorization unit 300 is attached to the manual stage 310, by manually rotating the coupling portion 309 for driving the control knob, the position of the precision device can be finely adjusted. As a result, the merit of the manual operation mode can be exerted in the automatic operation (or the electric operation mode) mode.

### Configuration of a First Example of a Second Embodiment of Manual Stage with Motorization Unit

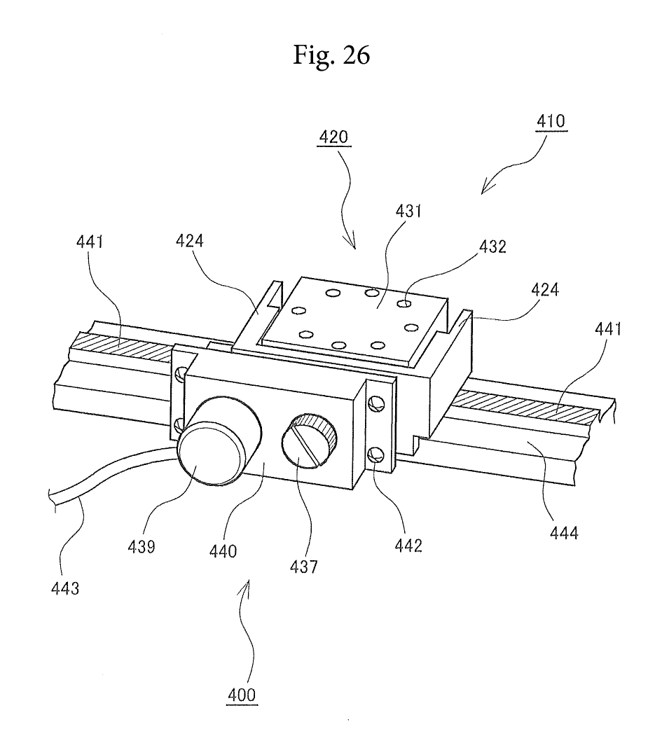

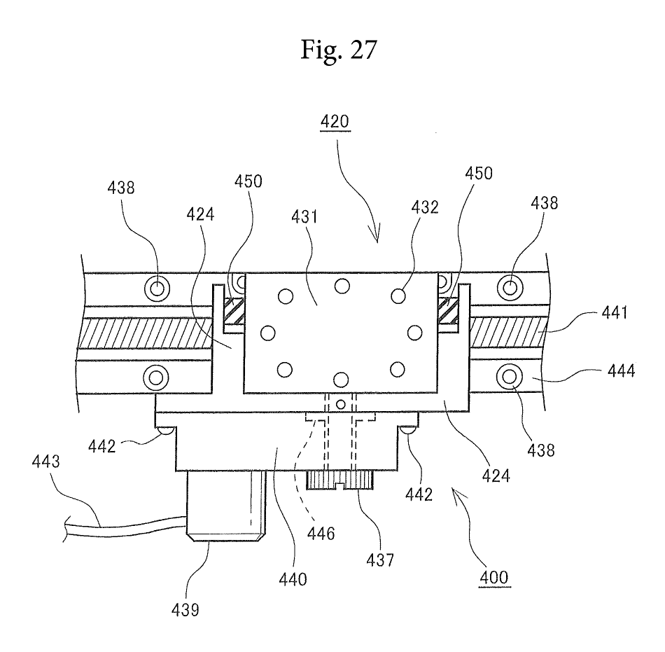

A first example of the second embodiment of a motorization unit 400 for a manual stage according to the present invention will be described below in detail with reference to the attached drawings. This first example is a variation of the second embodiment illustrated in FIGS. 3 and 4. FIG. 26 illustrates a schematic configuration of the first example of the motorization unit 400 for a manual stage in a perspective view. The motorization unit 400 for a manual stage is attached to a manual stage 410, and a function of the automatic stage is exerted in the manual stage 410. Moreover, FIG. 27 illustrates a plan view of the motorization unit 400 for a manual stage in FIG. 26. In the description for the first example below, the description similar to the second embodiment illustrated in FIGS. 3 and 4 is omitted, and only a difference from the second embodiment will be described. Therefore, those not in the description relating to the first example below in the description relating to the second embodiment illustrated in FIGS. 3 and 4 is incorporated.

As illustrated in FIGS. 26 and 27, this motorization unit 400 is different from the second embodiment illustrated in FIGS. 3 and 4 in a configuration of sandwiching/fixing portions 424 for sandwiching and fixing a sliding component 431 or a fixed component 444.

As illustrated in FIG. 27, the sandwiching/fixing portions 424 are arranged so as to sandwich the both sides of the sliding component 431 or the fixed component 444. Then, the sandwiching/fixing portions 424 are provided with elastic bodies 450 on the sides sandwiching the sliding component 431 or the fixed component 444, respectively. As a result, the sliding component 431 or the fixed component 444 is pressed from the both sides and fixed by an elastic force of the elastic bodies 450. That is, when the motorization unit 400 for a manual stage is to be attached to the manual stage 410, the right and left sandwiching/fixing portions 424 of the motorization unit 400 are slightly opened to sandwich the sliding component 431 or the fixed component 444. The elastic bodies 450 are slightly protruded from surfaces in contact with the sliding component 431 or the fixed component 444 of the sandwiching/fixing portions 424. Therefore, the elastic bodies 450 are compressed when the sandwiching/fixing portions 424 sandwich the sliding component 431 or the fixed component 444. When the right and left sandwiching/fixing portions 424 sandwich the sliding component 431 or the fixed component 444, the elastic bodies 450 are compressed and elastically deformed, and an elastic force to recover is generated. By means of this elastic force of the elastic bodies 450, the sliding component 431 or the fixed component 444 is pressed from the both sides and fixed. As a result, co-rotation can be reliably prevented by the elastic bodies 450 with a simple mechanism.

### Configuration of a Second Example of a Second Embodiment of Manual Stage with Motorization Unit

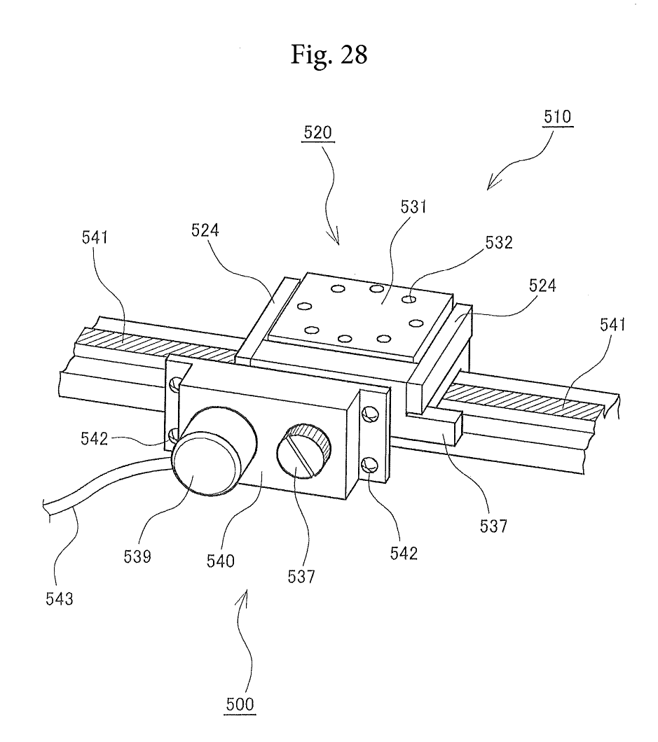

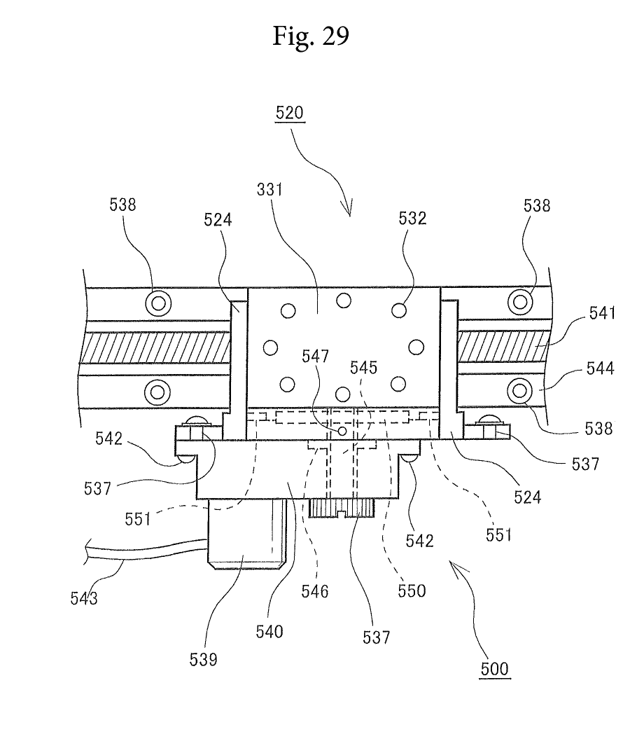

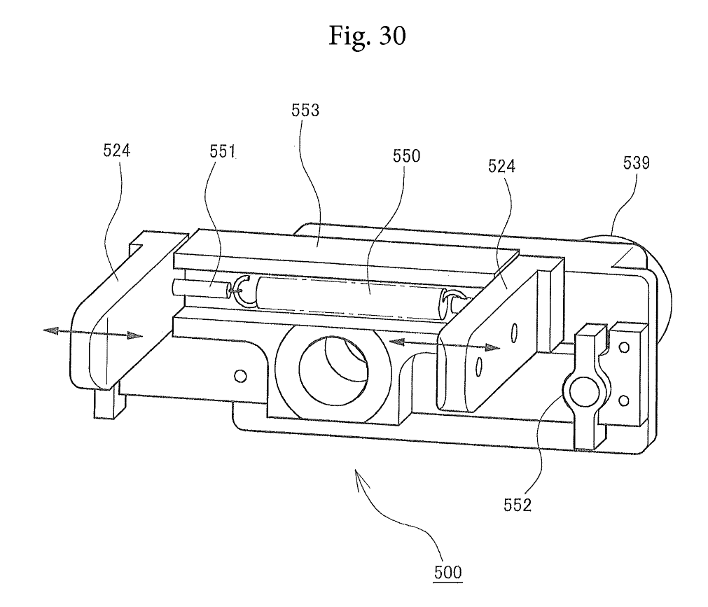

A second example of the second embodiment of a motorization unit for a manual stage according to the present invention will be described below in detail with reference to the attached drawings. This second example is a variation of the second embodiment illustrated in FIGS. 3 and 4. FIG. 28 illustrates a schematic configuration of the second example of the motorization unit 500 for a manual stage in a perspective view. The motorization unit 500 for a manual stage is attached to a manual stage 510, and a function of the automatic stage is exerted in the manual stage 510. Moreover, FIG. 29 illustrates a plan view of the motorization unit 500 for a manual stage in FIG. 28. Furthermore, FIG. 30 illustrates the motorization unit 500 for a manual stage in FIG. 28 in a perspective view seen from a side of the manual stage 510. In the description for the second example below, the description similar to the second embodiment illustrated in FIGS. 3 and 4 is omitted, and only a difference from the second embodiment will be described. Therefore, those not in the description relating to the second embodiment below in the description relating to the second embodiment illustrated in FIGS. 3 and 4 is incorporated.

As illustrated in FIGS. 28 and 29, this motorization unit 500 is different from the second embodiment illustrated in FIGS. 3 and 4 in a configuration of sandwiching/fixing portions 524 for sandwiching and fixing a sliding component 531 or a fixed component 544.

As illustrated in FIG. 29, the sandwiching/fixing portions 524 are arranged so as to sandwich the both sides of the sliding component 531 or the fixed component 544. Then, as illustrated in FIG. 30, the sandwiching/fixing portions 524 on the both sides of the sliding component 531 or the fixed component 544 are supported by a sandwiching/fixing portion reaction disk 553 and are provided with a spring 550 coupling the both. As a result, the sliding component 531 or the fixed component 544 is pressed from the both sides and fixed by an elastic force of the spring 550, and a reaction force of the elastic force of the spring 550 is borne by the sandwiching/fixing reaction disk 553. That is, when the motorization unit 500 for a manual stage is to be attached to the manual stage 510, the right and left sandwiching/fixing portions 524 of the motorization unit 500 are slightly opened to sandwich the sliding component 531 or the fixed component 544. As described above, by slightly opening the right and left sandwiching/fixing portions 524 of the motorization unit 500, the spring 550 is elastically deformed, and a tension to recover is generated. By means of this tension of the spring 550, the sliding component 531 or the fixed component 544 is pressed from the both sides and fixed. It should be noted that the sandwiching/fixing portions 524 are prevented from being removed by a fixing portion retainer 552. As a result, co-rotation can be reliably prevented by a simple mechanism using this spring 550, and the manual stage 510 is electrically operated by a motor 539.

### Configuration of a First Example of a Second Embodiment of Manual Stage

A first example of a manual stage 420 with a motorization unit according to the present invention will be described below in detail with reference to the attached drawings. FIG. 26 illustrates the first example of the manual stage 420 with a motorization unit in a perspective view. The manual stage 420 with a motorization unit is a stage in which the motorization unit 400 for a manual stage is connected to the manual stage 410. Moreover, FIG. 27 illustrates a plan view of the manual stage 420 with the motorization unit in FIG. 26. In the description for the first example below, the description similar to the second embodiment illustrated in FIGS. 3 and 4 is omitted, and only a difference from the second embodiment will be described. Therefore, those not in the description relating to the second embodiment below in the description relating to the second embodiment illustrated in FIGS. 3 and 4 is incorporated.

As illustrated in FIGS. 26 and 27, this manual stage 420 with a motorization unit is different from the second embodiment illustrated in FIGS. 3 and 4 in a configuration of sandwiching/fixing portions 424 for sandwiching and fixing a sliding component 431 or a fixed component 444.

As illustrated in FIG. 27, the sandwiching/fixing portions 424 are arranged so as to sandwich the both sides of the sliding component 431 or the fixed component 444. Then, the sandwiching/fixing portions 424 are provided with elastic bodies 450 on the sides sandwiching the sliding component 431 or the fixed component 444, respectively. As a result, the sliding component 431 or the fixed component 444 is pressed from the both sides and fixed by an elastic force of the elastic bodies 450. That is, when the motorization unit 400 for a manual stage is to be attached to the manual stage 410, the right and left sandwiching/fixing portions 424 of the motorization unit 400 are slightly opened, and the sliding component 431 or the fixed component 444 is sandwiched. The elastic bodies 450 are slightly protruded from surfaces in contact with the sliding component 431 or the fixed component 444 of the sandwiching/fixing portions 424 so that they are compressed when the sandwiching/fixing portions 424 sandwich the sliding component 431 or the fixed component 444. Therefore, when the right and left sandwiching/fixing portions 424 sandwich the sliding component 431 or the fixed component 444, the elastic bodies 450 are compressed and elastically deformed, and an elastic force to recover is generated. By means of this elastic force of the elastic bodies 450, the sliding component 431 or the fixed component 444 is pressed from the both sides and fixed. As a result, co-rotation can be reliably prevented by the elastic bodies 450 with a simple mechanism.

### Configuration of a Second Example of a Second Embodiment of Manual Stage

A second example of a manual stage 520 with a motorization unit according to the present invention will be described below in detail by using the attached drawings. FIG. 28 illustrates the second example of the manual stage 520 with the motorization unit in a perspective view. The manual stage 520 with a motorization unit is a stage in which the motorization unit 500 for a manual stage is connected to the manual stage 510. Moreover, FIG. 29 illustrates a plan view of the manual stage 520 with the motorization unit in FIG. 27. In the description for the second example below, the description similar to the second embodiment illustrated in FIGS. 3 and 4 is omitted, and only a difference from the second embodiment will be described. Therefore, those not in the description relating to the second example below in the description relating to the second embodiment illustrated in FIGS. 3 and 4 is incorporated.

As illustrated in FIGS. 28 and 29, this manual stage 520 with a motorization unit is different from the second embodiment illustrated in FIGS. 3 and 4 in a configuration of sandwiching/fixing portions 524 for sandwiching and fixing the sliding component 531 or a fixed component 544.

As illustrated in FIG. 29, the sandwiching/fixing portions 524 are arranged so as to sandwich the both sides of the sliding component 531 or the fixed component 544. Then, as illustrated in FIG. 30, the sandwiching/fixing portions 524 on the both sides of the sliding component 531 or the fixed component 544 are supported by the sandwiching/fixing portion reaction disk 553 and are provided with the spring 550 connecting the both. As a result, the sliding component 531 or the fixed component 544 is pressed from the both sides and fixed by an elastic force of the spring 550, and a reaction force of the elastic force of the spring 550 is borne by the sandwiching/fixing portion reaction disk 553. That is, when the motorization unit 500 for a manual stage is to be attached to the manual stage 510, the right and left sandwiching/fixing portions 524 of the motorization unit 500 are slightly opened, and the sliding component 531 or the fixed component 544 is sandwiched. As described above, by slightly opening the right and left sandwiching/fixing portions 524 of the motorization unit 500, the spring 550 is elastically deformed, and a tension to recover is generated. By means of this tension of the spring 550, the sliding component 531 or the fixed component 544 is pressed from the both sides and fixed. It should be noted that the sandwiching/fixing portions 524 are prevented from being removed by the fixing portion retainer 552. As a result, co-rotation can be reliably prevented by a simple mechanism using this spring 550, and the manual stage 510 is electrically operated by a motor 539.

1. A motorization unit for a manual stage, wherein:
the motorization unit for a manual stage is attached to a manual stage in which a sliding component to which a precision device is attached and a fixed component fixed to a base are coupled to each other via a driving mechanism, and the sliding component is moved by rotating operation of a control knob around its shaft in order to perform positional adjustment of the precision device;
the motorization unit for a manual stage is provided with:
a rotation preventing jig for preventing co-rotation by sandwiching the sliding component or the fixed component of the manual stage;
a coupling portion for driving the control knob connected to the control knob while holding substantial coaxiality with the control knob shaft;
a control knob gripping portion for gripping a knob portion of the control knob; and
a motor for rotating the coupling portion for driving the control knob;
and characterized in that either one of manual operation and automatic operation is selected by means of attaching/removing the motorization unit.

2. The motorization unit for a manual stage according to claim 1, characterized in that manual rotating operation of the coupling portion for driving the control knob rotates the knob portion of the control knob gripped by the control knob gripping portion so as to perform fine adjustment of a position of the precision device.

3. The motorization unit for a manual stage according to claim 1, characterized in that the rotation preventing jig is provided with an opening/closing mechanism which is a pair of clamps and removably sandwiches the sliding component or the fixed component by opening or closing both of tip-end portions of the clamps.

4. The motorization unit for a manual stage according to claim 3, characterized in that the opening/closing mechanism opens/closes the tip-end portion of one of the clamps by rotating a wheel coupled by rotating a gear around its axis, opens/closes the tip-end portion of the other clamp by rotating a spar gear meshed with the wheel in conjunction with the rotation of the wheel, and opens or closes the both tip-end portions of the pair of clamps.

5. The motorization unit for a manual stage according to claim 1, characterized in that the control knob gripping portion removably grips the knob portion of the control knob by a claw-shaped chuck device.

6. (canceled)

7. (canceled)

8. A motorization unit for a manual stage attached to a manual stage in which a sliding component to which a precision device is attached and a fixed component fixed to a base are coupled to each other via a driving mechanism, and the sliding component is moved by rotating operation of a control knob around its shaft in order to perform positional adjustment of the precision device, wherein the motorization unit is provided with:
sandwiching/fixing portions for sandwiching and fixing the sliding component or the fixed component;
a motorization unit main body coupled to the control knob of the sliding component or the fixed component while holding substantial coaxiality with the control knob shaft; and
a motor for rotating the control knob,
characterized in that either one of the manual operation and the automatic operation is selected by attaching/removing the motorization unit.

9. The motorization unit for a manual stage according to claim 8, characterized in that the sandwiching/fixing portions are in the form of a frame composed of a sandwiching plate having a bolt hole and a through bolt, the sliding component or the fixed component is sandwiched by the frame from both sides, and the sliding component or the fixed component is tightened by tightening a nut.

10. The motorization unit for a manual stage according to claim 8, characterized in that the motorization unit main body has a fine adjustment knob for manually rotating the control knob while holding substantial coaxiality with the control knob shaft of the sliding component or the fixed component.

11. The motorization unit for a manual stage according to claim 8, characterized in that the control knob shaft in which the knob portion has been removed from the control knob is coupled to the motorization unit main body.

12. (canceled)

13. (canceled)

14. A motorization unit for a manual stage attached to a feed-screw type manual stage in which a sliding component to which a precision device is attached and a fixed component fixed to a base are coupled to each other via a driving mechanism, and the sliding component by rotating operation of a control knob around its shaft in order to perform positional adjustment of the precision device, wherein the motorization unit is provided with:
a control knob gripping portion for gripping a knob portion of the control knob;
a coupling portion for driving the control knob coupled to the control knob of the sliding component or the fixed component while holding substantial coaxiality with the control knob shaft;
a motor for rotating the coupling portion for driving the control knob;
a rotation preventing jig for preventing co-rotation of a motor; and
a motor connecting portion connected to the motor and to which the rotation preventing jig is attached,
characterized in that either one of the manual operation and the automatic operation is selected by attaching/removing the motorization unit.

15. The motorization unit for a manual stage according to claim 14, characterized in that
the rotation preventing jig is a coupling shaft to be fitted into each of a plurality of fixing holes provided in a block on an end portion of the fixed component of the feed-screw type manual stage.

16. The motorization unit for a manual stage according to claim 14, characterized in that
manual rotating operation of the control knob gripping portion rotates the knob portion of the control knob gripped by the control knob gripping portion so as to perform fine adjustment of a position of the precision device.

17. The motorization unit for a manual stage according to claim 14, characterized in that
the coupling portion for driving the control knob is combined with the control knob gripping portion so as to integrally interlock the control knob shaft and the motor shaft with each other.

18. (canceled)

19. (canceled)

20. A motorization unit for a manual stage attached to a feed-screw type manual stage in which a sliding component to which a precision device is attached and a fixed component fixed to a base are coupled to each other via a driving mechanism, and the sliding component is moved by rotating operation of a control knob around its shaft in order to perform positional adjustment of the precision device, wherein the motorization unit is provided with:
a coupling portion for driving the control knob coupled to the control knob of the sliding component or the fixed component while holding substantial coaxiality with the control knob shaft;
a motor for rotating the coupling portion for driving the control knob;
a rotation preventing portion for preventing co-rotation of the motor; and
a motor connecting portion connected to the motor,
characterized in that either one of the manual operation and the automatic operation is selected by attaching/removing the motorization unit.

21. The motorization unit for a manual stage according to claim 20, characterized in that the rotation preventing portion is fixed by a fastening tool to a plurality of fixing holes provided on an end portion of the fixed component of the manual stage.

22. The motorization unit for a manual stage according to claim 20, characterized in that manual rotating operation of the coupling portion for driving the control knob rotates the control knob shaft of the manual stage so as to perform fine adjustment of a position of the precision device.

23. The motorization unit for a manual stage according to claim 20, characterized in that the coupling portion for driving the control knob is coupled to the control knob shaft in which the knob portion has been removed from the control knob.

24. The motorization unit for a manual stage according to claim 23, characterized in that the coupling portion for driving the control knob is coupled to the control knob shaft through a coupling shaft coupled to the control knob shaft.

25. The motorization unit for a manual stage according to claim 20, characterized in that the rotation preventing portion is formed integrally with the motor connecting portion and a control knob shaft supporting base and sandwiches the coupling portion for driving the control knob.

26. A feed-screw type manual stage in which a sliding component to which a precision device is attached and a fixed component fixed to a base are coupled to each other via a driving mechanism, and the sliding component is moved by rotating operation of a control knob around its shaft in order to perform positional adjustment of the precision device, characterized in that
automatic operation is made selectable by attaching a motorization unit provided with:
a coupling portion for driving the control knob coupled to the control knob of the sliding component or the fixed component while holding substantial coaxiality with the control knob shaft;
a motor for rotating the coupling portion for driving the control knob;
a rotation preventing portion for preventing co-rotation of the motor; and
a motor connecting portion connected to the motor.

27. (canceled)

28. (canceled)

29. (canceled)

30. (canceled)

31. (canceled)

32. (canceled)

33. (canceled)

34. (canceled)

35. (canceled)
